(19) United States
(12) Patent Application Publication
(10) Pub. No.: US 2006/0069730 A1
(43) Pub. Date: Mar. 30, 2006

(54) Public relations communication methods and systems

(76) Inventor: Hideyuki Azuma, Irvine, CA (US)

Correspondence Address: SMITH, GAMBRELL & RUSSELL, LLP, 1850 M STREET, N.W., SUITE 800, WASHINGTON, DC, 20036, US

(21) Appl. No.: 10/937,356

(22) Filed: Sep. 10, 2004

(51) Int. Cl. G06F 15/16

(52) U.S. Cl. 709/206

(57) ABSTRACT

An arrangement for distributing information from Information Providers (IP) to Information Recipients (IR) that utilizes the email system and the Internet to communicate with popular hardware devices—computers, PDAs, cellular phones, etc. IRs receive information anonymously and only the information desired. IPs do not need to “spam” the world in the hope of getting their information into the right hands because it is organized in a manner that allows IRs to receive exactly what they are looking for. Information is provided by an IP to an IR in response to a request from an IR. A PR server organizes and stores information uploaded by IPs, retrieves information requested by an IR and sends an automated response to the IR. A web domain is associated with the PR server provides a common email addressing scheme for communicating between the PR server and the IRs.

### BACKGROUND OF THE INVENTION

1. Field of the Invention

The way people communicate with each other is changing.

More and more people are communicating via their PCs, cellular phones, PDAs, etc. Email and instant messaging are replacing traditional mail. Web-based news is replacing printed newspapers. In the face of such change, a constant in the business world is the need to disseminate marketing and public relations information. There is a need to get relevant information into the hands of a desired target audience. Traditional marketing and public relations must evolve as the manner in which people communicate evolves.

For the purpose of this patent document, consider the world as being divided into Information Providers (IP), such as a business that wants to advertise its goods or services, and Information Recipients (IR), such as an individual who is looking for a bargain suit. IPs want to get information into the hands of IRs in an efficient manner. It is inefficient for an IP to spray digital “spam” everywhere in the hope of reaching a small subset of people in a desired target audience. That process is not only inefficient, it also breed ill will among IRs who don't want the information sent to them. IRs want to be able to easily get the information they want without sifting though lots of data they don't want. Often times, they also want to protect their anonymity.

Typically, an IR who desires to obtain information from an IP has to browse the web pages of each IP whose information is sought, or make numerous telephone calls to IPs to determine which one has a desired item or service. In the case of a web search, an IR must methodically navigate each IP's web page or use a search engine associated with the IP's website in order to locate the information desired. If an IR wants to find all Information of a particular IP, the IR must go to the web pages of that IP to retrieve the information (if it is on the website) or retrieve contact information for the IP and then send the

company an email or call the company.

An IR has four (4) ways to retrieve desired Information from an IP: 1) use a search engine and follow links associated with numerous “hits” one by one; 2) follow the link of a banner sponsor; 3) choose a program menu choice offered by a carrier, such as a cell phone carrier; and 4) receive spam mail, junk mail or a magazines.

Such methods are not preferred. Generally, the use of a search engine and clicking on “hits” takes longer than desired. Following the link of a banner sponsor or selecting a menu choice offered by a carrier provides limited information pre-selected by someone else. Even though a banner sponsor may have financial power, it may not be the best choice for a particular consumer (IR). Spam and junk mail are not desired. Approximately 90% of company web pages are useless to the typical IR. Generally people do not know the web address of an organization whose information is sought. It is difficult to find a web address from among the millions of listings in generic search engines.

### SUMMARY OF THE INVENTION

The inventions described herein generally relate to a comprehensive arrangement in which IPs disseminate information (including but not limited to marketing, public relations, job openings, discount coupons, sale information, campaign information, company profile, press releases, public announcements, job offers, etc.) to IRs who want to receive that information—and who actually request the information and receive it anonymously. Information is provided by an IP to an IR in response to a request from an IR. An information request may be made by an IR via a web browser interface on the Internet, by sending an email, or by sending a text message such as a “short message service” (SMS) message to the PR system requesting a certain kind of information. Desired information is retrieved from a database of such information and sent to the IR making the request.

The arrangements described support the various devices that people use to communicate and obtain information such as desktop PCs, notebook/laptop computers, cellular devices, PDAs, PHS devices, SMS devices, Blackberry devices. Satellite/Cable/Fiber Cable communications systems, Palm devices, hand-held computers, and other data communication devices. A public relations information server (PR server) stores information provided by the IPs and disseminates information to the IRs when prompted to do so by a request from an IR. There is a web domain associated with the PR server. For example, that domain might be “PRaddress.com”. This domain forms the basis for a common email addressing scheme to be used for communications between the PR server and the IRs. This common address is important because it will become known to IRs and form the basis for various information request messages. By utilizing the common address scheme, an IR is able to access desired information 24 hours a day 365 days a year. An IP can update its information on the PR server at any time via the Internet to allow fast changing information, such as sale information to be disseminated rapidly to IRs. The near “universal” nature of the arrangements presented herein provide a common ground for businesses, consumers and even governmental agencies to easily communicate with one another. It is a tool that can be utilized by cellular phone carriers, Internet Service Providers (ISP), search engine companies, email companies, etc. An IR that is email capable needs only to send a blank email message, properly addressed, to a PR server and receive an auto reply with desired information contained therein or attached thereto.

Each IP has a number of ways that it can be identified by in IR. Each IR has a number of “aliases” such as a code number, a code name and a company name. Such aliases can be advertised by conventional means such as billboards, posters, TV, radio, etc. so that they become known to potential IRs. For example, a young man looking for a job at an ABC Hamburger shop in New York could simply send a blank email to job@abch.nvc.PRaddress.com and receive, in reply a list of job openings at ABC Hamburger Shops in New York.

It is possible for an IR to access desired information in many ways, not just by knowing a particular alias of a company whose information the IR wants. For example there are search engines available on the PRaddress.com domain for carrying out a generalized search for the type of information desired. IPs affiliate themselves with a particular “category” of organization. As the system evolves, categories can be added and deleted as their popularity is continuously assessed.

This categorization helps IRs refine their searches.

Information uploaded into the PR system by IPs is organized into a plurality of “subjects”. Information pertaining to a particular “subject” such as “job opportunity” can be later retrieved without the need for an IR to wade through lots of irrelevant information not related to job opportunities. IPs can upload information to as many of the “subject” categories as may be relevant to the IPs business. Information on the PR system is accessible by IRs 24 hours a day and 365 days a year through an easy to remember PR address and domain, such as PRaddress.com. As with “categories”, “subjects” can be added and dropped as culture evolves and the popularity of each is continuously assessed.

An IP can be an individual, a business entity or an organization. For example, IPs include commercial business corporations, commercial partnerships, non-profit organizations, religious organizations, charitable organizations, governmental agencies, etc.

IRs can access the PR server through various communication channels and modes of communication. An IR can access via an Internet connection, direct dial up to the PR server, via cellular phone call, etc. IRs are able to receive the contents of PR Information by a return message in response to a message directed to the PR server that includes some “tag” identifying what information is desired, i.e. a PR code number, PR code name, a “subject”, or “category”.

An IR is able to retrieve specific information from a particular IP by using a PR code or other alias associated with that particular IP. Or, the IR can receive information related to a particular “subject” or “category” by using the subject or category name in the information request sent to the PR server. If an IR has access to an Internet web page, formatted either for PC viewing or cellular handset viewing or PDA viewing, the IR can easily search for information by using a directory system including a menu structure or by using a search engine built into PRaddress.com. There is also provided an index of PR codes and names associated with company names. Thus, all that an IR needs to know is a company name to retrieve specific information from that company.

An IR is able to search for information through a variety of communication means and modes and through a variety of ways that the information is organized. The PR system provides a code name and a code number to each IP that becomes a member of the system. These codes can be used by an IR to search for desired information.

Using the principles of the inventions described herein, an IR no longer has to browse the web pages of each IP from which information is sought. With the PR system described in this patent IRs can get a Information contents organized by subject, such as, for example, 16 “subjects”, by sending e-mail without necessarily connecting Internet.

An IR can get all Information contents of 16 “subjects” if the IR knows ONE code number or code name of a IP that the IR wants to get Information from. PRaddress.com issues and publishes PR address book that includes a code number (numerically), a code name (alphabetically), a company name and location (city, state and zip code). An IR does not need to search among thousands of web pages and doesn't even need to connect through Internet to find information such as organized into the 16 “subjects” of PRaddress.com.

An IR can utilize a PR address book (Information Providers Codes, a code number and a code name of PR system) and Data Communication Terminal Unit that has e-mail function.

If an IR wants to find all Information of a particular IP, the IR can go to the homepage of PRaddress.com and send email or call them up.

The described PR system is a convenient Information source, which is a narrow to a point. Therefore, PR system is situated in middle of Internet homepage and e-mail/mail magazines.

PR codes can become an identifier of the type that might be printed on a business card handed to someone met during networking.

Example: (1) web address (www.abc-humburgershop.com),

(2) email address (peter@abc-humburgershop.com)

(3) PR codes (@10234.PRaddress.com,@ abch.PRaddress.com)

With a common PR codes, both IPs and IRs are able to utilize the PR system anytime and anywhere where wired or wireless connectivity is available.

### BRIEF DESCRIPTION OF DRAWINGS

FIG. 1 is a schematic diagram illustrating basic concepts of the inventions.

FIG. 2 is a schematic diagram illustrating various ways that Information Recipients (IR) and Information Providers (IP) can access and work with the PR System.

FIG. 3 is a schematic diagram of a simplified but suitable database structure for storing information about IPs.

FIG. 4 is a schematic diagram illustrating an example of operation of the inventions.

FIG. 5 is a schematic diagram setting forth further details about the PR system.

FIG. 6 is a schematic diagram illustrating concepts relating to information requests via email addressing.

FIG. 7 is a drawing of a sample home page of PRaddress.com.

FIG. 8 is a schematic diagram of a form used by an information provider to register to become a member as an information provider with PRAdress.com.

FIG. 9 is a schematic diagram of a sign in web page for a “member” of PRAdress.com as an information provider.

FIG. 10 is a schematic diagram of a web page that acts as a gateway for the IP member.

FIG. 11 is a schematic diagram of PRaddress.com web page including a search engine for use by an IR for locating desired information.

FIG. 12 is a schematic diagram of a PRaddress.com web page used to search for PR information by PR-Category.

FIG. 13 is a schematic diagram of a PRaddress.com web page used to search for PR information by PR-Subject.

FIG. 14 is a schematic diagram of a PRaddress.com web page used to search for PR information by PR-Subject.

FIG. 15 is a schematic diagram of a PRaddress.com web page used to search for PR information by PR-Subject.

FIG. 16 is a schematic diagram illustrating use of PRaddress.com by a cellular phone user that does not have an Internet browser built into his cellular phone but does have a text message service available and wants to search by “PR Index/Directory, Category, Subject and Code number/name”.

FIG. 17 is a schematic diagram of a web page formatted for a cellular phone user whose phone does have an Internet browser built in. The cellular user may or may not have access by a direct connection (dial up service).

FIG. 18 is a schematic diagram illustrating use of PRaddress.com by a PC/Notebook user with a direct connection (dial up service).

### DETAILED DESCRIPTION

The inventions described herein generally relate to public relations. More specifically, the inventions are related to commercial and/or non-commercial systems and methods for disseminating promotional and public information including advertising, discount coupons, public relations information, marketing information, etc. The inventions also include methods for utilizing these systems and methods in business. Collectively, these concepts will be referred to as a “PR system” for convenience even though the claimed inventions are not limited to “systems”, but rather are broader in scope, including methods as well.

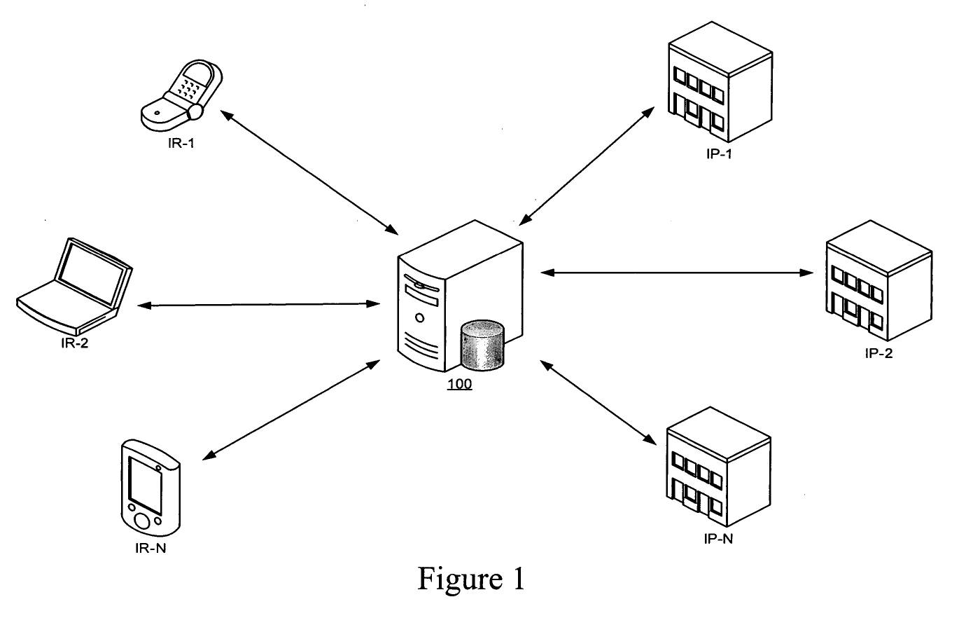

FIG. 1 is a schematic diagram illustrating basic concepts of the inventions. Stated in its most general form, core concepts of the inventions relate to systems and methods for collecting information from Information Providers (IP-1, IP-2, IP-N), organizing that information, and making that information available easily accessible to Information Recipients (IR-1, IR-2, IR-N) via a PR system.

The heart of the PR system is represented in FIG. 1 by a PR server 100 that has at least a database and database access software, email functionality and means for communicating in a variety of modes, manners and protocols with both the Information Providers (IPs) and the Information Recipients (IRs). In a practical arrangement, the functions of PR server 100 will be carried out by multiple servers appropriately interconnected for carrying out database, email, domain and other functions to facilitate handling a large volume of data traffic. IR-1, IR-2 and IR-3 and “pictured” and represented in FIG. 1 by a cellular device, a laptop computer and a PDA to illustrate the universal availability of the PR system to users of different types of devices and communication methods.

An IP who wants to disseminate information to the public (potential IRs) joins the PR system and becomes a “member” IP. An IP member subscribes to various services offered by the PR system. These services may include being allowed to upload information related to certain “subjects” that can be disseminated to IRs for free;

upload information related to other “subjects” that can be disseminated to IRs for a fee; email banner sponsorship, web page banner sponsorship, etc. An IP members can upload information that it wants to distribute. Uploaded information may include, for example, information needed to prepare electronic discount coupons, job availability, information about a sale or promotion, etc.

Upon joining as a member, the IP is assigned a code number, a code name and an initial password. IP member information, such as company name, location, zip code, and other identifying data, along with the assigned code number, code name and password and information uploaded by the IP are organized and stored in one or more databases associated with PR server 100 for later searching and retrieval. The organization of the information includes maintaining a database that links information to be disseminated with pertinent company information and the assigned code number and code name.

An IP selects a “category” of organization with which it would like to affiliate. As an example, there are eighteen (18) categories:

| | | | | |
|---|---|---|---|---|
| News | Sports | Movies | Music | Health |
| Beauty | Friends | Autos | Laws | Weather |
| Travel | Education | Money | Real Estate | PC & Mobile |
| Internet | Restaurant | Food & Drink | | |

A request by an IR that is limited to a particular “category” will only retrieve information uploaded by organizations that have affiliated with the category requested.

An IP can upload information into a plurality of different “subjects”. For example, there are sixteen (16) “subjects”:

| | | | |
|---|---|---|---|
| Information | Job Offer | Press | Announcement |
| Notice | Report | Investor | New |
| Hot | Sale | Member | Price List |
| Special | Coupon | Discount | Public Relations |
| | | | (PR) |

An IP can upload information in one or more of these “subjects”, as applicable. The classifications of “category” and “subjects” is flexible and may change from time to time as the system evolves. As culture changes, some “categories” and “subjects” will go out of favor and others will take their places.

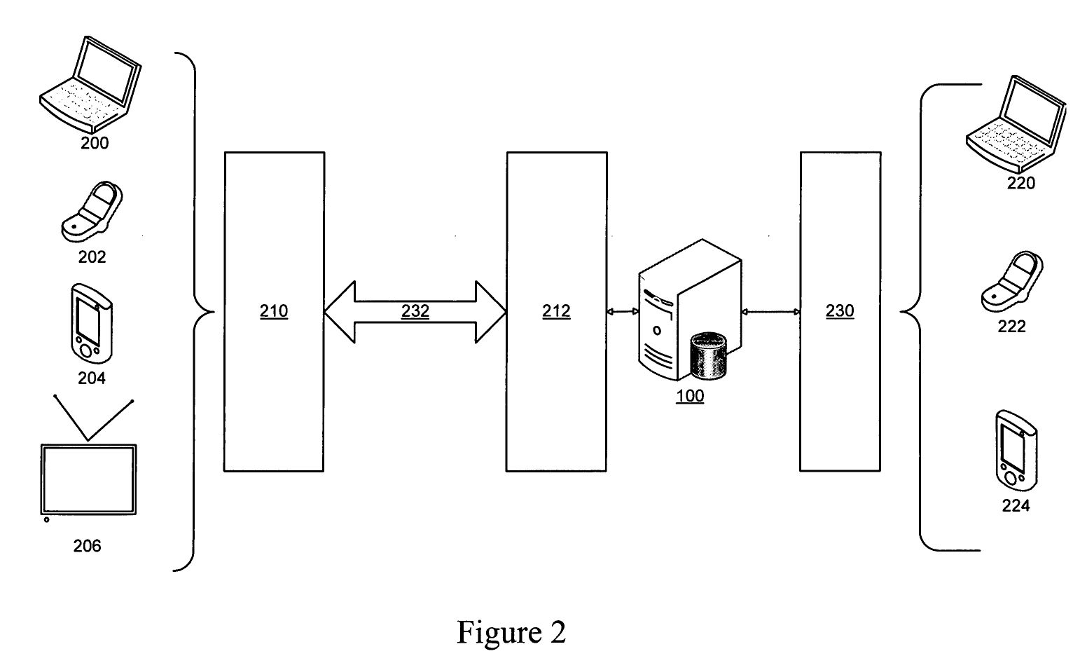

An IR who wants to obtain information from an IP is able to access the PR system in via a number of communication modes (see FIG. 2) and also locate the information in a variety of ways. An IR is able to request and locate information in the following ways: (1) search engine (2) menu navigation system, and (3) email system.

IRs can access the data stored in the database by using a search engine Associated with PR server 100. The search engine software may be stored on each server on which database information is stored, or it may run on a different server. Using search engine software, an IR is able to search for the desired information by entering key words, such as company name, code name, code number, company location, etc.

An IR can also locate information on PR server 100 via a menu navigation system. The menu navigation system includes a plurality of menus providing an IR with the ability to select choices and refine a request for information by category, subject, etc.

The menu navigation system is provided on the PR server 100 for users who connect directly to the PR server or who access the PR server via the Internet. For those users who access the PR server via a third party, such as, for example, a cellular carrier, the PR system may be a service choice on a menu navigation system provided by the third party. Thus, that menu selection would be the gateway point into the PR system for such users.

An IR can also obtain desired information from the PR system by sending an email message (typically a blank message) to PR server 100 via an associated email domain. For example, an email domain is established, such as, for example, “PRaddress.com”. Emails addressed to this domain would eventually be routed to PR server 100. A portion of the email address (typically the front portion of the address) is coded in a manner that tells PR server 100 what information is desired. The email, when received, is processed to determine what information is sought. This is done by parsing the email address (sent to address) to obtain search criteria for locating the desired information. The database is queried based on the parsed information. Database information located as a result of this query is formatted into an email message that is automatically returned to the sender. This auto reply email may include banner advertising by an IP who has previously purchased the right to be an “email banner sponsor”.

FIG. 2 is a schematic diagram illustrating various ways that Information Recipients (IR) and Information Providers (IP) access and work with the PR System. It is intended that the PR system be universally available to IPs and IRs who utilize a variety of communication tools and modes of communication. IPs generate information and upload that information on the PR system. Information uploaded to PR server 100 by an IP can include, for example: press releases, job openings, discount coupons, sale announcements, investor relations information, sale advertisements, promotional information, etc. The PR system organizes the IP's information, stores it, and makes it available to IRs who seek such information, and may remain anonymous if they wish.

IRs access the PR system, search for and retrieve information provided by the IPs. The IR can access the PR System using a PC/Notebook 200, a cellular device, such as a cellular phone 202, a mobile communication device (for example, Palm device, Blackberry, PDA, PHS or other portable device) 204, or TV/Cable /Fiber Cable/Satellite/ or any digital wireless monitor type device, symbolized in the figure by TV 206.

PC users, cellular phone users, Mobile/Data communication terminal users (PDA, Palm device, Blackberry, SMS, PHS, and others), AOL Instant Messenger users, service and text message users who access via the Internet and/or dial-up (Direct) access, etc.

Devices 200, 202, 204 and 206 gain access through any of multiple types of communication means 210, such as but not limited to: dial-up, DSL/ADSL, Fiber, Broadband, Fiber Cable, Satellite, Wi-Fi, TDMA, CDMA, CDMA 2000, WCDMA, GSM, GPRS, EDGE, 3GSM, MMS, SMS, HSCSD, WAP, UMTS, IMMARSAT, Ricochet, PDC (Japan), PHS, TD-CDMA, or other protocols. Arrow 232 represents both Internet and dial-up or some other type of communication. Depending upon the type of communication chosen, communication can take place in any of a variety of formats/protocols 212 to PR Server 100. The various formats/protocols 212 include but are not limited to: E-mail, Text/Instant Message/File, Picture/Video Message/File, Html Message/File, XmI Message/File, Xhtml Message/File, Animation File, Compression File, Java Script/File, AOL Instant Messenger Service, Short Message Service, QR-code, Bar-code, and any other data communication method & File, service menu.

Information Providers (IP) communicate with PR Server 100 using a variety of hardware devices such as PC/Notebook 220, cellular device, such as a cellular phone 222, and PDA/Mobile/Palm device/Blackberry/PHS, etc. 224. An IP can communicate with PR Server 100 by a variety of communication means 230, such as but not limited to: Internet, dial-up (direct without Internet connection), Service Menu—PR System service provided through cellular phone carriers, internet providers & carriers, search engine companies, Blackberry, PDA, PHS, Mobile Carriers, Palms, AOL, SMS and Cable/Fiber Cable/Satellite carrier, any other data communication system & method.

It is intended that the PR system be universally utilized by IPs and IRs that communicate using a variety of devices and communication services. At the time of this writing the following communication means and protocols are available and are presented as a non-limiting example in the following matrix of devices and communication services:

For Information Providers (IPs) with both Internet connection and dial-up direct connection, the means available in block 230 include but are not limited to:

| | PC/ | Digital | Pock- | | | | |
|---|---|---|---|---|---|---|---|
| | Note- | Internet | et | Cellular | | | Black- |
| | book | TV | PC | Phone | PDA | Palm | berry |
| Dial up | ◯ | ◯ | ◯ | ◯ | ◯ | ◯ | ◯ |
| DSL/ADSL | ◯ | ◯ | ◯ | ◯ | ◯ | ◯ | ◯ |
| Cable | ◯ | ◯ | ◯ | ◯ | ◯ | ◯ | ◯ |
| Fiber | ◯ | ◯ | ◯ | ◯ | ◯ | ◯ | ◯ |
| Satellite | ◯ | ◯ | ◯ | ◯ | ◯ | ◯ | ◯ |
| Wi-Fi | ◯ | ◯ | ◯ | ◯ | ◯ | ◯ | ◯ |
| TDMA | ◯ | ◯ | ◯ | ◯ | ◯ | ◯ | ◯ |
| CDMA | ◯ | ◯ | ◯ | ◯ | ◯ | ◯ | ◯ |
| CDMA2000 | ◯ | ◯ | ◯ | ◯ | ◯ | ◯ | ◯ |
| WCDMA | ◯ | ◯ | ◯ | ◯ | ◯ | ◯ | ◯ |
| PDC(Japan) | ◯ | ◯ | ◯ | ◯ | ◯ | ◯ | ◯ |
| GSM | ◯ | ◯ | ◯ | ◯ | ◯ | ◯ | ◯ |
| GPRS | ◯ | ◯ | ◯ | ◯ | ◯ | ◯ | ◯ |
| EDGE | ◯ | ◯ | ◯ | ◯ | ◯ | ◯ | ◯ |
| 3GSM | ◯ | ◯ | ◯ | ◯ | ◯ | ◯ | ◯ |
| MMS | ◯ | ◯ | ◯ | ◯ | ◯ | ◯ | ◯ |
| SMS | ◯ | ◯ | ◯ | ◯ | ◯ | ◯ | ◯ |
| HSCSD | ◯ | ◯ | ◯ | ◯ | ◯ | ◯ | ◯ |
| WAP | ◯ | ◯ | ◯ | ◯ | ◯ | ◯ | ◯ |
| UMTS | ◯ | ◯ | ◯ | ◯ | ◯ | ◯ | ◯ |
| INMARSAT | ◯ | ◯ | ◯ | ◯ | ◯ | ◯ | ◯ |
| Ricochet | ◯ | ◯ | ◯ | ◯ | ◯ | ◯ | ◯ |
| Direct access | ◯ | ◯ | ◯ | ◯ | ◯ | ◯ | ◯ |
| PHS | ◯ | ◯ | ◯ | ◯ | ◯ | ◯ | ◯ |
| TD-CDMA | ◯ | ◯ | ◯ | ◯ | ◯ | ◯ | ◯ |
| CD-ROM | ◯ | ◯ | ◯ | ◯ | ◯ | ◯ | ◯ |
| DVD-ROM | ◯ | ◯ | ◯ | ◯ | ◯ | ◯ | ◯ |
| Document | ◯ | ◯ | ◯ | ◯ | ◯ | ◯ | ◯ |
| Software | ◯ | ◯ | ◯ | ◯ | ◯ | ◯ | ◯ |

For Information Recipients (IRs) with both Internet connection and dial-up direct connection, the communication means/protocols of blocks 210 and 212 include but are not limited to:

| | PC/ | | Pock- | | | | |
|---|---|---|---|---|---|---|---|
| | Note- | Digital | et | Cellular | | | Black- |
| | book | TV | PC | Phone | PDA | Palm | berry |
| Dial up | ◯ | ◯ | ◯ | ◯ | ◯ | ◯ | ◯ |
| DSL/ADSL | ◯ | ◯ | ◯ | ◯ | ◯ | ◯ | ◯ |
| Cable | ◯ | ◯ | ◯ | ◯ | ◯ | ◯ | ◯ |
| Fiber Cable | ◯ | ◯ | ◯ | ◯ | ◯ | ◯ | ◯ |
| Satellite | ◯ | ◯ | ◯ | ◯ | ◯ | ◯ | ◯ |
| Wi-Fi | ◯ | ◯ | ◯ | ◯ | ◯ | ◯ | ◯ |
| TDMA | ◯ | ◯ | ◯ | ◯ | ◯ | ◯ | ◯ |
| CDMA | ◯ | ◯ | ◯ | ◯ | ◯ | ◯ | ◯ |
| CDMA2000 | ◯ | ◯ | ◯ | ◯ | ◯ | ◯ | ◯ |
| WCDMA | ◯ | ◯ | ◯ | ◯ | ◯ | ◯ | ◯ |
| PDC(Japan) | ◯ | ◯ | ◯ | ◯ | ◯ | ◯ | ◯ |
| GSM | ◯ | ◯ | ◯ | ◯ | ◯ | ◯ | ◯ |
| GPRS | ◯ | ◯ | ◯ | ◯ | ◯ | ◯ | ◯ |
| EDGE | ◯ | ◯ | ◯ | ◯ | ◯ | ◯ | ◯ |
| 3GSM | ◯ | ◯ | ◯ | ◯ | ◯ | ◯ | ◯ |
| MMS | ◯ | ◯ | ◯ | ◯ | ◯ | ◯ | ◯ |
| SMS | ◯ | ◯ | ◯ | ◯ | ◯ | ◯ | ◯ |
| HSCSD | ◯ | ◯ | ◯ | ◯ | ◯ | ◯ | ◯ |
| WAP | ◯ | ◯ | ◯ | ◯ | ◯ | ◯ | ◯ |
| UMTS | ◯ | ◯ | ◯ | ◯ | ◯ | ◯ | ◯ |
| INMARSAT | ◯ | ◯ | ◯ | ◯ | ◯ | ◯ | ◯ |
| Ricochet | ◯ | ◯ | ◯ | ◯ | ◯ | ◯ | ◯ |
| PHS | ◯ | ◯ | ◯ | ◯ | ◯ | ◯ | ◯ |
| TD-CDMA | ◯ | ◯ | ◯ | ◯ | ◯ | ◯ | ◯ |
| Direct | ◯ | ◯ | ◯ | ◯ | ◯ | ◯ | ◯ |
| access | | | | | | | |
| CD-ROM | ◯ | ◯ | ◯ | ◯ | ◯ | ◯ | ◯ |
| DVD-ROM | ◯ | ◯ | ◯ | ◯ | ◯ | ◯ | ◯ |
| Document | ◯ | ◯ | ◯ | ◯ | ◯ | ◯ | ◯ |
| Software | ◯ | ◯ | ◯ | ◯ | ◯ | ◯ | ◯ |

The above is not intended to be an exhaustive list. The infrastructure of cable/wireless data communication technologies<Dial up, DSL/ADSL, Cable, Fiber Cable, Satellite, Wi-Fi, TDMA, CDMA, CDMA2000, WCDMA, PDC(Japan), GSM, GPRS, EDGE, 3GSM, MMS, SMS, HSCSD, WAP, UMTS, INMARSAT, Ricochet, PHS, TD-CDMA, Direct access, CD-ROM, DVD-ROM, Document, Software> changes rapidly and continues to evolve. Rather, it is intended to convey to the reader that the PR system described herein is “universally” available to users, regardless of their preferred device and means of communication.

Software that includes information about how to use the PR system and that provides search templates, etc can be distributed to potential IRs in a number of ways: CD-ROM, DVD-ROM, downloadable via the Internet, via cellular carriers, etc.

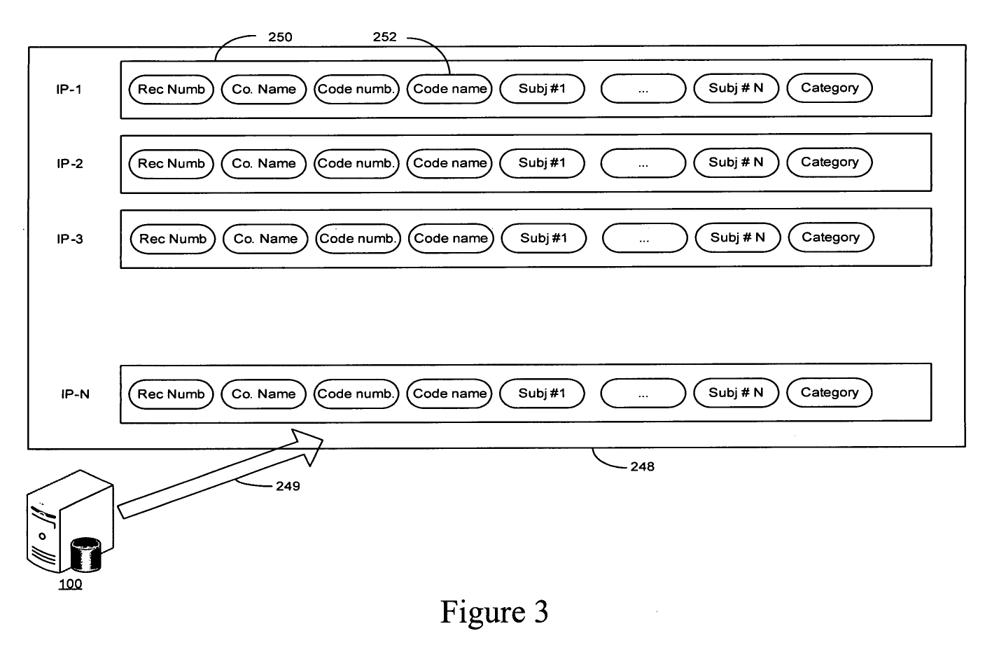

FIG. 3 is a schematic diagram of a simplified but suitable database structure for storing information about IPs. A PR server database 248 is stored on PR server 100, as symbolized by arrow 249.

Database 248 includes multiple records, such as record 250, with at least one record for each IP. Each record includes multiple fields, such as the “Code Name” field 252. Each record includes, for example, fields for “record number”, “company name”, “code number”, “code name”, “subject #1” . . . “subject # N”, and “category”. Each IP can associate itself with a “category”. Each IP can upload information for each of the defined “subjects”. For example, for the subject called “job information” IP-3 might upload text describing a job opportunity at one of its shops in New York. For the subject called “sale”, IP-3 might upload the text of a discount coupon that offers 10% off a purchase when the coupon is printed and presented to a store clerk.

Example of PR System Operation

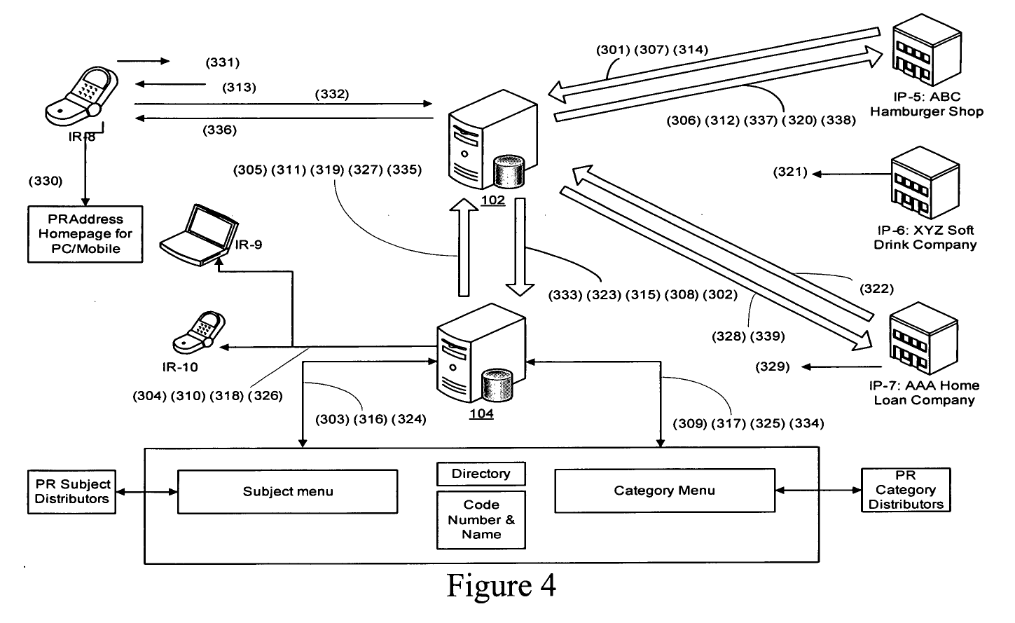

The inventions described herein are explained by describing an example of operation in FIG. 4. As an illustrative example, consider a scenario in which there are three information providers IP-5, IP-6 and IP-7. IP-5 is the ABC Hamburger Shop (ABCh), IP-6 is the XYZ Soft Drink Company, and IP-7 is the AAA Home Loan Company. IP-6 is an E-mail Banner Sponsor. IP-7 is a Homepage Banner Sponsor. Three IRs: IR-8, IR-9 and IR-10 are symbolized by cell phones (IR-8 and IR-10) and a PC (IR-9).

There is established an Internet domain for the PR system and the domain is associated with the PR server 100. In this example, the domain is “PRaddress.com”. Of course other domain names can be used. There is established a “home page” for PRaddress.com on either a dedicated domain server or on a shared server. This home page serves as one gateway into the PR system for users including information providers (IPs) and information recipients (IRs) that have Internet access. The PR system also maintains its own network for direct access (such as dial-up service) without accessing through the Internet.

The PR system can be accessed by users of various types of communication devices (see FIG. 1) who want to receive PR information, including but not limited to PC users, cellular phone users, Mobile/Data communication terminal users (PDA, Palm device, Blackberry, SMS, PHS), AOL Instant Messenger users, service and text message users who access via the Internet and/or dial-up (Direct) access, etc.

In this example, PR server 100 (shown in FIGS. 1 and 2) comprises two servers 102 and 104. In practical embodiments there will be a plurality of servers in order to serve the number of IPs and IRs expected. However, for the sake of simplicity of explanation, a two server system is described in this example. Server 102 functions as a mail server/web server/client server. Server 104 functions as a database server/directory server/category server/subject server/code #/name server. Software loaded onto at least one of the servers includes at least: 1) a search engine having a template for searching information by PR code number/PR code name/Subject/Category/Keyword; and 2) email address parsing and auto-reply software for responding to inquiries that arrive via email. Together, the operation of servers 102 and 104 will be referred to as the “PR system” or “PRaddress.com”.

A home page (such as shown in FIG. 4) associated with PRaddress.com includes links for at least the following:

a) What is PR address?

b) How to use PR address?

c) Information Recipient

d) Information Provider

e) Banner Sponsor

f) Partner

g) System

h) Frequently Asked Questions (FAQ)

i) IP member LOG IN

PRaddress.com advertises for Information Recipients (IR), Information Providers (IP) and Banner Sponsors to utilize its PR solution. PRaddress.com cooperates with Internet Service Provider (ISP) companies, Search Engine companies, ADSL carriers, satellite/cable/fiber cable carriers, mobile communications carriers (PDA, Palm devices, Blackberry, SMS, PHS, etc,) and cellular phone carriers in order to be universally available, i.e. a global standard.

At (301) a potential IP (IP-5) applies, through an online secured CGI form linkable from www.PRaddress.com, to become a member of the PR system. Once the IP has become a member and has uploaded information it wants to distribute and that information is stored in database 248 (see FIG. 2B), an IR can access information uploaded to the PR server by the new IP. An IP can indicate a particular “category” of IP with which it wants to be associated. For example, IP-5 chooses to be “categorized” as a “restaurant”. IP-5 uploads information into as many of the “subject” that apply to its business. For example: <Info=Company Information><Notice=Public Notice> and <Job=Job Offer >. According to the PR system business model, certain types of information can be uploaded and disseminated free of charge. Other types of information can be uploaded and disseminated for a fee. It is expected that a number of IPs will utilize some but not all of the services made available by the PR server, such as, for example, advertising a job opening or becoming an email banner sponsor.

A potential IP is able to sign up as an IP by pointing a web browser to the home page of the PR server, such as PRaddress.com. In the alternative, a potential IP can get an application form to apply to become an IP by sending a blank e-mail to register@PRaddress.com. An automated e-mail reply system will send the required sign up form with an automated reply. A reply email from

PRaddress.com also includes a link to a web page of PRaddress.com and/or provides a server address for another Internet Service Provider (ISP) such as, for example, America On Line (AOL), a PR menu and dial-up (direct access) information.

An IP that is registering with PRaddress.com configures itself to accept an e-mail reply from PRaddress.com by adjusting its spam blocker or other filter accordingly so that emails from PRaddress.com are not blocked. The PR system uses known automated reply e-mail technology that is installed into PR server 102 functioning as an email server. For example, a blank email is sent by an IR whose email address is JoeCitizen@bigisp.com. This blank email is addressed to: job@10234.nvc.PRaddress.com

and is received by server 102. Parsing software stored on server 102 parses the email address and extracts pertinent information: “job”, “10234”, and “nyc”. It queries database 248 and retrieves the information stored in the subject field “job” related to jobs in New York that are offered by the IP having code number 10234. The retrieved information is then incorporated into a reply email sent to JoeCitizen@bigisp.com.

At (302) PRaddress.com stores basic information about ABC Hamburger (IP-5) into server 104 which maintains database 248 by setting up a record related to ABC Hamburger. Server 104 assigns an ID code number, a code name and an initial password to ABC Hamburger (IP-5). The ID code number may be, for example, 10234. The code name for ABC Hamburger might be, for example, “ABCh”. The code number and code name are used to create additional PR email addresses for ABC Hamburger (IP-5). Using the exemplary code number and code name, an email inquiry to the PR system for ABC Hamburger could be addressed to either: “----@10234.PRaddress.com” or “----@abch.PRaddress.com”.

The initial password can be randomly generated or generated according to some predetermined algorithm by server 102 and can later be changed by the registered IP. ABC Hamburger can use the code number and code names and password to log into a FREE PR Box area of the PR server through the PRaddress.com home page when ABC Hamburger wants to upload or update any of its information to be disseminated.

At (303) the database 248 is organized into various “portions”.

For example, one portion may be a free content area and other may be a paid content area. Since ABC Hamburger is registered as a IP member, ABC Hamburger is able to utilize PR fields dedicated to <Company Info.> <Public Notice><Job Offer>, etc. and edit its information stored in those areas. All IP members including banner sponsors will have PR “boxes” to store data related to each “subject” This information is ultimately stored in appropriate fields of database 248. Certain “boxes” can be designated as “free” and others may have a fee associated with their use.

At (304) PRaddress.com updates by adding Information about ABC Hamburger into the PRaddress.com website with an indication that ABC Hamburger is a new IP member. PRaddress.com establishes several type of web pages and a menu top page which are compatible with all popular data communication terminals and other devices such as PC, Cellular phones, PDA, Palms, Blackberry, SMS, PHS and others through Internet, AOL, PR menu and Dial-up (direct) access. At (305) the database server 104 directs email server 102 to reply PR Information of ABC Hamburger.

At (306) PRaddress.com informs ABC Hamburger that <ID# 10234> has been assigned to ABC Hamburger along with the code name <ABCh> and password <10 KyrB89>. Other information is also provided to ABC Hamburger, such as for example, <How to use PRADDRESS.COM system> <about Paid PR> <about Banner Sponsor> by sending an e-mail to the newly registered IP.

At (307) ABC Hamburger agrees to pay for PR advertising so that ABC Hamburger can advertise a sale on hamburgers. It opens a SALE box after reading about Paid PR Information from PRaddress.com. The terms of sale in this example includes advertising for a duration of 1 month from Jul. 10th to Aug. 9th of 2004. The sale language will be <$0.50 off any hamburger> <Free drink> <All stores nationwide>. For disseminating this sale ad by email, ABC Hamburger agrees to pay $0.20 per e-mail inquiry from an IR and reply to that IR without counting duplicate e-mail addresses. ABC Hamburger can regularly log into the members area of PRaddress.com and check its statistics to determine in real time the volume of email traffic generated by its sale ad. At (308) and (309) the ad text is stored into a PAID PR area of server 104 and stored in one or more appropriate fields of database 248.

At (310) the PR system updates its data to add the SALE information about ABC Hamburger that was just arranged. The information is not only linked with the IP's code number, code name and company name, but is also classified in a manner that allows an IR using web page or menu access to locate the information by search engine or menu selection. For example, an IR can search using a menu system by clicking on successive menu choices, such as
<SALE>→<Food & Drink>→<FastFood>→<ABC Hamburger>, or
<Food & Drink>→<Fast Food>→<ABC hamburger>.

The IR can search using the search engine by entering one or more keywords, such as, for example, <10234> or <ABCh> into a search engine interactive keyword box to get a quick access for ABC Hamburger.

At (311) and (312) information is sent to ABC Hamburger about setting up for PR SALE. Having registered its SALE information on the PR server, at (313) ABC Hamburger will promote and advertise its SALE to potential IRs (and all customers) throughout its stores, on posters, Media advertisings (TVs, Magazines, Radios), ABC Hamburger website, etc. ABC Hamburger may say, for example, on an advertising poster: “Send a blank mail to SALE@10234.PRaddress.com or SALE@abch.PRaddress.com and receive valuable SALE information from ABC Hamburger”. An IR who follows these instructions will receive a reply from the PR system that includes the SALE information.

The PR system can issue a coupon or a voucher with bar code included as an option. It can issue a standard design coupon at no additional charge or an original design coupon for ABC Hamburger for an extra fee depending upon the size and style of graphics desired. When an IR sends an email to the PR server and receives a reply email with SALE/COUPON/DISCOUNT from ABC Hamburger (or receives the SALE information by searching the web or using a menu structure) and shows the email to a clerk at an ABC Hamburger Shops, the IR will get the sale promotional benefit set forth in the SALE information.

At (314) XYZ Soft Drink Company (IP-6) agrees to purchase some promotion on the PR system. In addition to the normal email reply SALE information described above with respect to ABC Hamburger, XYZ Soft Drink Company also becomes a banner sponsor by paying an extra fee for such advertising. In this case, reply emails to IRs will include a banner advertisement by the XYZ Soft Drink Company. XYZ Soft Drink Company enters into an agreement with the PR system including terms under which a banner will be displayed to an IR. For example, an XYZ Soft Drink Company banner will appear on 10,000 email replies to IR inquiries beginning on Sep. 6, 2004. The banner might read, for example:
<<<Get a free coupon of XYZ drink at http://www.xyzdrink.com >>>

The price of such banner advertising might be, for example, 10,000 e-mails @ $0.15 per each mail. As with ABC Hamburger (IP-5), XYZ soft drink company (IP-6) also can use PR address after being issued a code number, a code name and password.

At (315) and (316) the PR system registers XYZ Soft Drink Company as IP-6 and provides a member account for XYZ Soft Drink Company. XYZ Soft Drink Company is given access to 16 selectable “subject” boxes which XYZ Soft Drink Company can use to categorize itself. For example, it may select to be listed under “FOOD & DRINK”.

At (317) the PR system inputs data and Information of XYZ Soft Drink Company for email banner advertising. The PR system, based on a predetermined algorithm, decides which email responses should include a display of the XYZ Soft Drink Company banner. At the beginning of operation, when the PR system has few members, the XYZ Soft Drink Company email banner will be attached to all email replies. When, on the other hand, there are many members, the PR server will attach the XYZ Soft Drink Company banner to only certain email replies and will select those replies for maximum advantage to XYZ Soft Drink Company, such as, for example, replies relating generally to the category of services provided by XYZ Soft Drink Company. such as drink, food, restaurant and fast food.

At (318) PRaddress.com updates Information of XYZ soft drink company as a NEW IP member. At (319) and (320) PRaddress.com provides a code number, a code name and a randomly selected password to be associated with XYZ soft drink company. For example the ID number is <4118> and the code name is <xyzsd>. Thus, an IR will be able to send an email to “---@4118.PRaddress.com” or to “----@xyzsd.PRaddress.com” and receive a reply including the sale information of XYZ Soft Drink Company. Later, the XYZ Soft Drink Company, now an IP member, can change its password, update its company information, select subject and category information, etc. by logging onto the PR system web page at PRaddress.com. It can also check its performance statistics when desired. These statistics will include the number of email replies and other retrievals of information and the number of email banners displayed.

At (321) XYZ Soft Dink Company promotes and advertises how to access its information uploaded to the PR system. It may do so through the use of conventional media such as posters, Media advertisings (TVs, Magazines, Radios), its website, etc. The sale advice provided in this conventional media can simply be:
<Send a blank email to coupon@4118.PRaddress.com or to coupon@xyzsd.PRaddress.com and receive a valuable coupon issued by XYZ Soft Drink Company.>

The PR server can issue a standard coupon or a voucher or a special design coupon or voucher with or without a bar code and with or without an infrared code. Extra fees may apply for special coupons. An IR using a cell phone or PDA with a small screen may be able to only receive a simple text file. Coupons and other information provided by the PR system will be formatted in a number of ways to provide universal access.

At (322) AAA Home Loan company agrees to become a member and also agrees to purchase top banner PR advertising on the PRaddress.com homepage. It becomes IP-7. AAA Home Loan company enters into an agreement with the PR system for a 3 month term for a fee of $1,000 per month. A banner to be displayed on the home page of PRaddress.com might read:
<Get 7.5% Home Loan at http://www.AAAhomeloan.com>

When AAA Home Loan Company joins the PR system, it is issued a code number, a code name and an initial password. At (323) and (324) the PR system registers AAA Home Loan company as IP member IP-8 and opens an account for AAA Home Loan company. The AAA Home Loan Company is then given access to select subject and categories under which it would like to be listed for menu and search purposes. In this example, the AAA Home Loan Company affiliates itself with the category of “money”. This affiliation is “marked” by the proper entry in the “category” field of the IP-8 record in database 248.

At (325) the PR system inputs data and information related to AAA Home Loan Company and programs an advertising banner for display at the top of the PRaddress.com homepage. Early in its operation, when there are few IP members, the banner of AAA Home Loan Company may be displayed frequently. As the number of IP members grows, the top banner space may be shared with others in some kind of sequence. As an alternative, the banner may be displayed as a “flash” banner for an extra fee.

At (326) the information about AAA Home Loan Company is stored. The PR system issues a code number, a code name and an initial password for AAA Home Loan Company. For example the ID number assigned is <5005> and the code name assigned is <aaahl> Thus, the PR addresses of AAA Home Loan Company will be “----@5005.PRaddress.com” and “----@aaahl.PRaddress.com”. AAA Home Loan Company can use those 2 PR addresses immediately. AAA Home Loan Company can log into the members area of PRaddress.com and make subject and category selections so that IR users can easily find the information of AAA Home Loan Company by menu selection and by the use of the search engine. AAA Home Loan Company can check its performance statistics when desired.

At (329) AAA Home Loan Company promotes and advertises how to access its new PR address to its potential customers through posters, business cards, catalogue, Media advertisings (TV. Magazines, Radio), and on the AAA Home Loan Company website. Through these conventional media, AAA Home Loan Company advises its potential customers to
<Send a blank mail to PR@5005.PRaddress.com or PR{fourth root}aaahl.PRaddress.com and get a valuable Information from AAA Home Loan>.

At (330) Information Recipients (IR) are learning about the PR system and about PRaddress.com solution through Internet, search engines, magazines, etc. At (331) IRs are also getting to know about PR solution by advertisings from Information Providers (IPs) and Banner Sponsors.

At (332) IR-8 learns a PR address of ABC Hamburger that is promoting a coupon for <$0.50 off Hamburger, free Fizzy Soda at any ABC for a limited time (October 10th-November 9). The IR sends e-mail to
<sale@abch.PRaddress.com> or
<sale@10234.PRaddress.com>ps to receive a PR SALE message reply.

At (333) and (334) the PR system parses the addressee portion of the email and obtains the search terms “sale”, “abch” or “sale”, “10234” depending on which email address was used. This parsed information is then used to query database 248 stored in server 104 and retrieve the sale information associated with ABC Hamburger from the appropriate field or fields of data. The retrieved data is incorporated into a reply email at 335 which is sent via email auto-reply software at 336 to IR-8. This email includes an email banner from email banner sponsor XYZ Soft Dink Company (IP-6). The email reply may be a fully formatted email or a text message depending upon equipment and communication method used by IR-8. The email message content is:
<$0.50 off any Hamburger, Free Coke>

The reply e-mail which IR receives has a banner advertisement of XYZ soft drink company—also in the text file. The IR takes the email to any ABC Hamburger Shop and shows it to a clerk to obtain the advertised benefit. If the IR is feels uncomfortable to send his initial email inquiry from a proper e-mail address, he can make a second/transfer e-mail from the PRaddress.com homepage or any other free anonymous e-mail system such as Yahoo or Hotmail. IR can get many other valuable coupons and other information by accessing the PR system through its website—PRaddress.com either via the Internet or via a direct (dial-up) connection.

At (337) PRaddress.com provides a performance report during the term of its agreement to ABC hamburger Shop. At (338) PRaddress.com provides a performance report to XYZ soft drink company. At (339) PRaddress.com provides a performance report to AAA home loan company.

The PR system described by way of this example is available to potential customers (IRs) to receive information from a variety of businesses and business types. IRs can locate and retrieve desired information while providing or not providing their identity to avoid any privacy issues. The PR system is universally available to users of many different kinds of communication devices communicating using various protocols. PR system has a usability with Internet, cable/fiber cable/satellite, AOL Instant Messenger Service, SMS, Palms, Blackberry, Text Message , Dial-up (Direct Access) with PR system and any other Data Communication Methods by any other cellular phone carriers, PHS, PDA/Mobile Communication Carriers, Internet Carriers and others.

The example depicted in FIG. 3 is an example written mainly for Internet access indicating a) web site b) homepage c) address d) e-mail e) www. f) .com g) @ as Internet is a common way to access. However, users without Internet access can also use the PR system by direct access (including dial-up) without using Internet. There are two ways to make direct access to the PR system without utilizing the Internet:

1) Dial-up with PR service access point; and

2) Access via a service menu of a carrier.

Many carriers, such as, for example, cellular carriers, Internet carriers, cable/Satellite/Fiber Cable Carriers, PHS/PDA/Palms/Blackberry/AOL and other data communication carriers now offer “service menus” that are accessed via a phone number or some other access. Examples of such service menus include “i-mode” service offered via NTT DoCoMo and “T-zone” service offered by T-Mobile. Services with such service menus are actually systems run on servers typically that are directly accessed via a carrier user. Such service providers can enter into a agreements with the PR system to link to the PR system in such a manner that the PR system can become a service menu item on such systems.

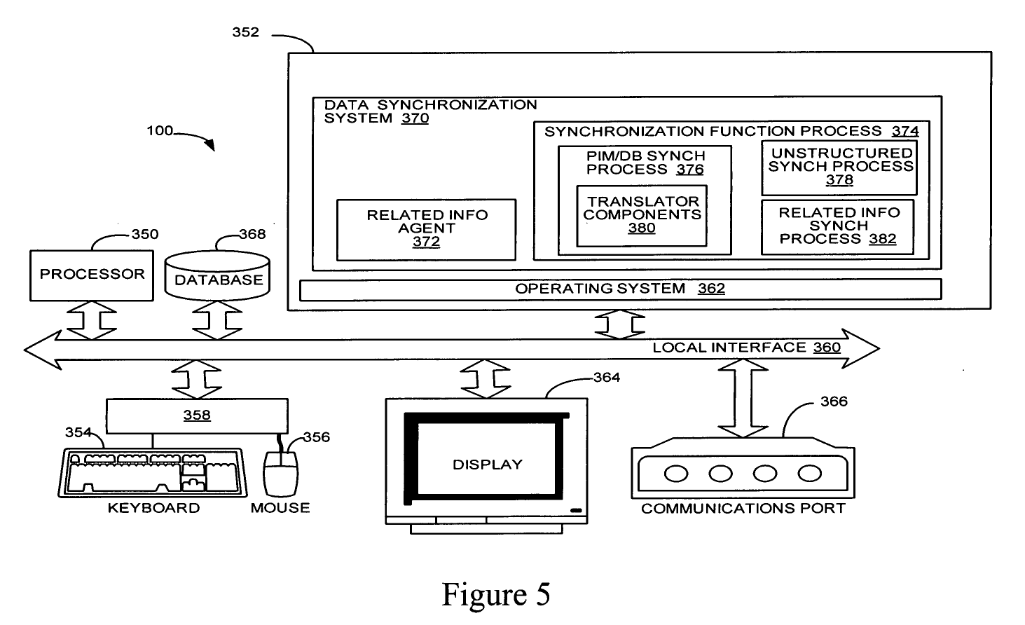

FIG. 5 is a schematic diagram setting forth further details about the PR system. The PR system is preferably implemented by a combination of hardware and software. The core “hardware” of the PR system is represented by PR server 100 in FIGS. 1 and 2. In a practical system, PR server 100 is implemented by two or more servers such as PR server 102 and 104 shown in FIG. 3. The number of individual “boxes” is a matter of design choice. Generally, it makes sense, given the technology at the time of this writing to implement the functions of PR server 100 on two or more boxes. For the sake of description in this patent, FIG. 3A describes a possible construction of a single server implementation of PR server 100.

The functions of PR server 100 can be implemented in software (e.g., firmware), hardware, or a combination thereof. In the currently contemplated best mode, most functions are implemented in software, as one or more executable programs, and are executed by a special or general purpose digital computer, such as a personal computer (PC;

IBM-compatible, Apple-compatible, or otherwise), workstation, minicomputer, or mainframe computer, configured to function as a “server”. An example of a general purpose computer that can implement the PR system functions is shown in FIG. 5. Thus, the term “server computer” will be used interchangeably with “server” in this description.

Generally, in terms of hardware architecture, as shown in FIG. 5, the server computer 100 includes a processor 350, memory 352, and one or more input and/or output (I/O) devices (or peripherals), represented by keyboard 354, mouse 356, both connected through an input device interface 358 that are communicatively coupled via a local interface 360. The local interface 360 can be, for example but not limited to, one or more buses or other wired or wireless connections, as is known in the art. The local interface 360 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 350 is a hardware device for executing software, particularly that stored in memory 352. The processor 350 can be any custom made or commercially available processor, a central processing unit (CPU), an auxiliary processor among several processors associated with the server computer 100, a semiconductor based microprocessor (in the form of a microchip or chip set), a microprocessor, or generally any device for executing software instructions. Examples of suitable commercially available microprocessors are as follows: a PA-RISC series microprocessor from Hewlett-Packard Company, an 80x86, i960, Pentium, Celeron, Xeon or Itanium series microprocessor from Intel Corporation, a PowerPC microprocessor from IBM, a Sparc microprocessor from Sun Microsystems, Inc, or a 68xxx series microprocessor from Motorola Corporation.

The memory 352 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 352 may incorporate electronic, magnetic, optical, and/or other types of storage media. Note that the memory 352 can have a distributed architecture, where various components are situated remote from one another, but can be accessed by the processor 350.

Database hardware/software 368 is coupled to local interface 360. A data synchronization system 370 is provided to process and synchronize data in database 368 and memory 352. Data synchronization system 370 includes a related information agent 372, and a synchronization process function 374. Synchronization process function 374 includes PIM/DB Synch Process 376, unstructured synch process 378, translator components 380, and related information synchronization process 382.

Database hardware/software 368 stores data related to the operation of the PR system. This data includes data related to each of the IP members. Data stored in database 368 is organized into one or more database tables (constituting “database” 248 which are organized into records, each record having multiple fields. As an exemplary embodiment, database 248 includes for each IP, the name of the IP, one or more locations of the IP, the code number assigned to the IP, the code name assigned to the IP, an identifier of any categories with which the IP is associated, fields for data associated with “subjects” and a category identifier and other identifiers indicating what services the IP has subscribed to.

Database 248 and associated database management software is stored in one or more digital files including data related to IPs, etc. together with code, which when executed causes to occur the required operations of searching, sorting, recombining, and other functions. Database 248 can be queried by various known means such as, for example, SQL or via a search engine.

The software in memory 352 may include one or more separate programs, each of which comprises an ordered listing of executable instructions for implementing logical functions. The software in memory 352 includes software which when executed causes or enables all of the functionality of the PR system in accordance with the inventions described and/or claimed herein and a suitable operating system (O/S) 362. PR system software includes software for managing inquiries from IRs and responding to them with automated email reply. This software includes software for parsing an incoming email to extract from the address portion of the email data related to information sought by an IR, querying database 368, compiling a reply to the IR making the request and automatically sending that reply. A non-exhaustive list of examples of suitable commercially available operating systems 22 is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation). The operating system 362 essentially controls the execution of other computer programs, such as those required for carrying out the functionality of the PR system, and provides scheduling, input-output control, file and data management, memory management, and communication control and related services.

PR system software may include source programs, executable programs (object code), script, and any other entity comprising a set of instructions to be performed. A source program needs to be translated via a compiler, assembler, interpreter, or the like, which may or may not be included within the memory 352, so as to operate properly in connection with the O/S 362. Furthermore, the software of the PR system can be written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices may also include, for example but not limited to, a scanner (not shown), microphone, etc. (not shown). Furthermore, the I/O devices may also include output devices, for example but not limited to, a printer, display 364, etc. Finally, the I/O devices may further include devices that communicate both inputs and outputs, for instance but not limited to, a NIC or modulator/demodulator (for accessing other files, devices, systems, or a network), a radio frequency (RF) or other transceiver, a telephonic interface, a bridge, a router, etc.

If computer server 100 is a PC, workstation,, intelligent device or the like, the software in the memory 352 may further include a basic input output system (BIOS) (omitted for simplicity). The BIOS is a set of essential software routines that initialize and test hardware at startup, start the O/S 362, and support the transfer of data among the hardware devices. The BIOS is stored in ROM so that the BIOS can be executed when the computer server 100 is activated.

When the computer server 100 is operating, the processor 350 is configured to execute software stored within the memory 352, to communicate data to and from the memory 352, and to generally control operations of the computer server 100 pursuant to the software.

The PR system software and the O/S 362, in whole or in part, but typically the latter, are read by the processor 352, perhaps buffered within the processor 350, and then executed.

A communications port 366 allows for communication with IPs and IRs via a variety of means, as shown in FIG. 2. Thus, communications port 366 represents the hardware/software/firmware needed to communicate according to each of the means and protocols described. Thus communication port 366 communicates with a dedicated network associated with the PR system, and one or more shared networks that connect the PR server 100 with Internet Service Providers, telephone carriers, cell carriers, packet data networks, satellite networks, cable networks, etc.

PR system software can be stored on any computer readable medium for use by or in connection with any computer related system or method. In the context of this document, a computer readable medium is an electronic, magnetic, optical, or other physical device or means that can contain or store a computer program for use by or in connection with a computer related system or method.

PR system software can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where all or some of the functionality of the PR system is implemented in hardware, the PR system can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

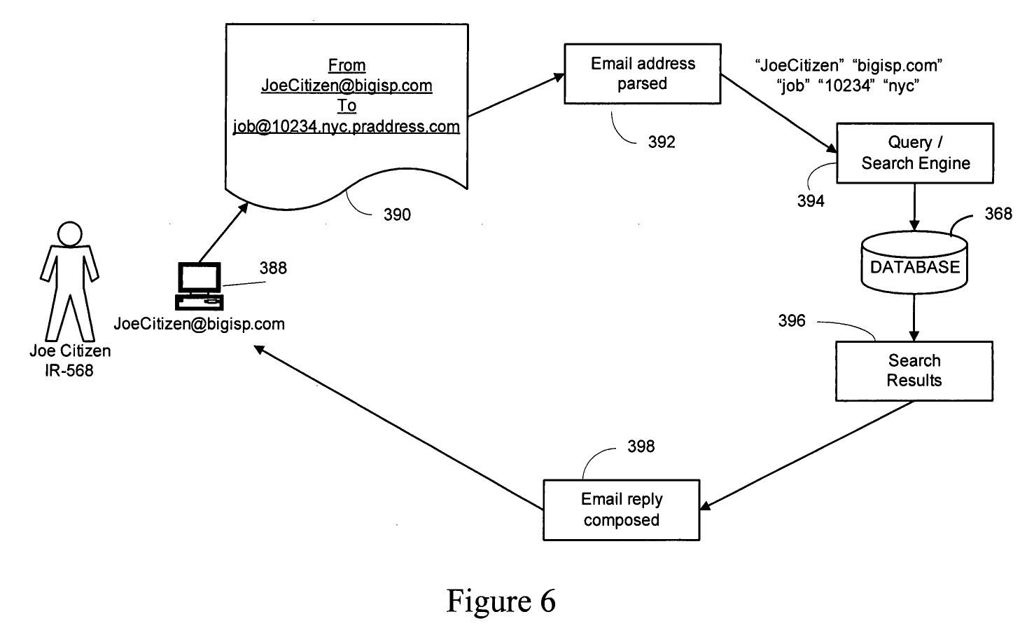

FIG. 6 is a schematic diagram illustrating concepts relating to information requests via email addressing. Consider the example, described above wherein Joe Citizen (IR-568) is looking for a job in New York at an ABC Hamburger Shop. Joe Citizen's email address is JoeCitizen@bigisp.com. Joe Citizen uses his computer 388 to send a blank email 390 over the Internet via bigisp.com. Email 390 is addressed to:
job@10234.nvc.PRaddress.com

The PR system parses at 392 the incoming email and extracts from the address portion the pertinent information built into the email address: “job”, “10234”, and “nyc”. At 394, query software searches database 368 for the information desired.

Database 368 is queried by using appropriate software such as SQL or a search engine. The search locates among the information stored by IP members records related to job openings at various ABC Hamburger Shops in New York. In this example, the PR system retrieves JOB data linked with “10234” and “nyc”. Search results are compiled at 396. At 398 an automated email reply to Joe Citizen is composed including the search results compiled at 396.

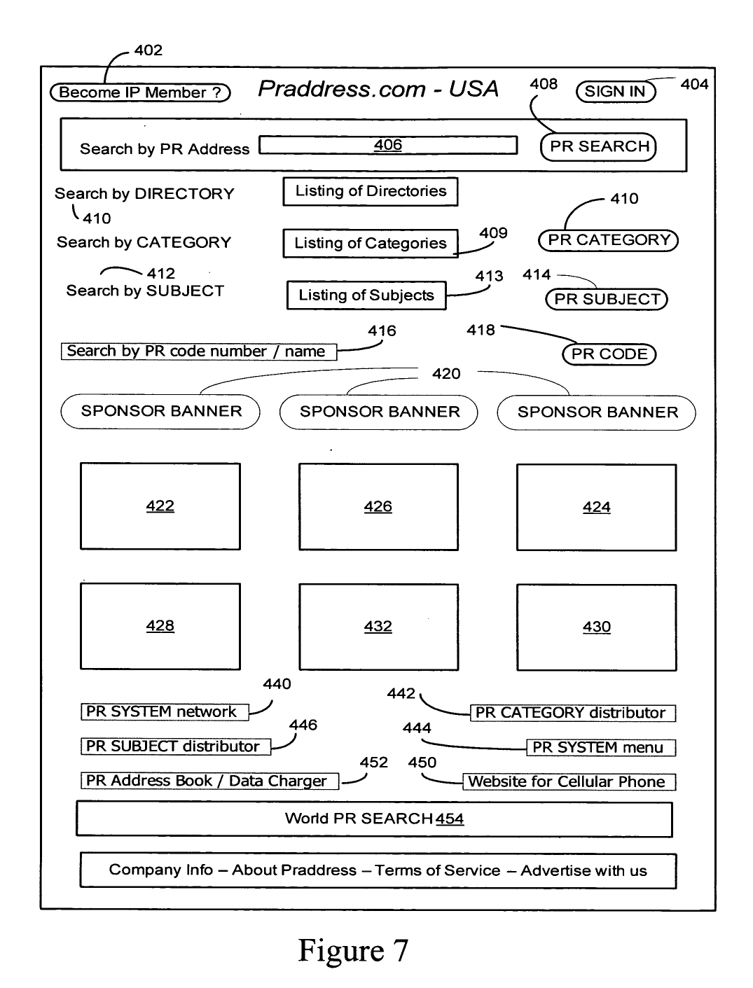

FIG. 7 is a schematic diagram of an exemplary homepage for PRaddress.com as seen by a PC-based user. The web pages of PRaddress.com allow users with Internet service to have an easy gateway into the PR system. As already mentioned, this is not the only way users can access the PR system. The home page takes a user to other pages in the web of PRaddress.com through clickable links, software programming, etc. A clickable button 402 asks user is asked whether he/she would like to become a IP member (become an information provider). A clickable button 404 provides a PRaddress.com member an opportunity to sign in. After sign in, an IP member can edit and update various “subjects” (for example 16 “subjects”) at anytime.

The home page includes a search template and appropriate links to a search engine associated with PR server 100. An interactive box 406 allows the user to enter search terms. The user then clicks on a clickable button 408 to cause a search to be carried out. The search engine enables an information seeker to search for information using a PR code number, a PR code name, an article, a keyword, etc. The home page also includes links that can provide the user with additional information. As an example, the home page might include links to sub-pages of the PRaddress.com web, such as “What is PR address?”, “Information Recipient”, “Information Provider”, “Banner Sponsor”, “Partner”, “System”, “Frequently Asked Questions (FAQ)”, and “IP member Log In”.

Interactive box 406 allows a user to input keywords, PR code number, PR code name for a PR search. A PR search is quite different from the searches performed by typical search engines such as encountered on “Yahoo”, “Google”, “MSN”, “Excite”, etc. A PR search is a much more “targeted” search that is not searching the entire universe of web pages. It is, in essence, a query of a database holding limited information from a limited number of IPs. An IR inputs key words that identify specific “subject” areas and “categories” for company information desired. For example, when IR doesn't know a code number or code name of IP, the IR might select a single “category” and perhaps a single “subject” of interest, a location (city and state or zip code) and input them as keywords into block 406. For example, If the IR is looking for a part time job at a Hamburger Shop in New York City, the IR will input <Restaurant Hamburger Job NYC>.

At 410 a IR “beginner” might start to search PR IP members by Directory which provides a menu structure such as: “Business & Economy”, “Computers & Internet”, “News & Media”, “Entertainment”, “Recreation & Sports”, “Health”, “Government”, “Countries, Regions, US States”, “Society & Culture”, “Education”, “Arts & Humanities”, “Science” and “Social Science”. For example, when IR clicks Business & Economy, then next screen will be seen many categories which IRs are categorized when register. If an IR chooses “Food & Restaurant”, then the next screen shows hundreds of IP members who have associated themselves with that category. If the IR then narrows his choice to “Fast Food” the IR can then view a list of all IP members with PR code number, code name, company name and location.

At 411 there is an opportunity to search by Category (for example, 18 pre-defined Categories) that are selected by PR system as most usable categories for both IRs and IPs. A category search is simple to use, but does not have the elaborate directory structure provided by the directory search. For example if an IR clicks on the category “Money” he immediately sees a list of all IPs and associated PR code numbers, code name, company name and location that have affiliated themselves with the “money” category. After an IR decides to choose one IP members from among those listed, the IR selects one of 16 “subjects” about which he would like to retrieve information. A list of categories 409 might include:

| | | | | |
|---|---|---|---|---|
| News | Sports | Movies | Music | Health |
| Beauty | Friends | Autos | Laws | Weather |
| Travel | Education | Money | Real Estate | PC & Mobile |
| Internet | Restaurant | Food & Drink | | |

At 412 and 414 there is an opportunity to search by “subjects” (for example, 16 “subjects” which are selected by PR system as most usable subject content for both IRs and IPs). The difference between Category Search and Subject Search is that the Category Search is to search by Type of Business and the Subject Search is to search by Type of PR Contents of IR members. For example, when IR click <Job offer>, one of 16 “subjects”, the next screen shows Category lists and click one of 18 Categories (type of business) to narrow to a point. A list of “SUBJECTS” 413 might include:

| | | | |
|---|---|---|---|
| Information | Job Offer | Press | Announcement |
| Notice | Report | Investor | New |
| Hot | Sale | Member | Price List |
| Special | Coupon | Discount | PR |

At 416 and 418 the user (IR) has an opportunity to search by PR code number. This is for IR who already knows a code number, a code name of IR. The codes can be organized into groups for easy location, such as “1-9999, 10000-99999, 100000- 999999, 10000000-9999999.” Each PR information provider is assigned a PR code number in the range of, for example, 1-9,999,999. If an user (Information Recipient) knows a PR code number, such as “10234” of ABC Hamburger, IR can receive job information in response to inputting “10234 JOB” as a key word in a search engine to view a PR message board within a JOB subject on a screen and/or to receive a PR message within a JOB subject by sending an email at JOB@10234.PRaddress.com.

At 420 Sponsor banners are located on each PR homepage. As an example, three “Sponsor Banners” are illustrated. As examples, banner sponsors could be available for:

PR address website for PC

PR address website for cellular phone

PR subject website

PR subject website for cellular phone

PR subject box of all information suppliers, and

PR subject box of all return mail from information suppliers.

Blocks 422, 426 and 424 are intended for users with Internet access to PRaddress.com. Blocks 428, 430 and 432 are intended for users without Internet access to PRaddress.com. Users without Internet connection can access the PR system though access points provided by our own network affiliated with the PR system. This network can include network affiliates who provide access points through various direct connections such as dial-up service.

Blocks 422 and 428 are intended for PC users. Blocks 426 and 432 are intended for cellular/PDA users. Blocks 424 and 430 are intended for cellular users that have text message capability (including short message service—SMS) devices.

At 422, there is a clickable button is labeled “PC/Notebook User with Internet Connection—Click HERE to send a PRaddress Search Engine template to your email.”

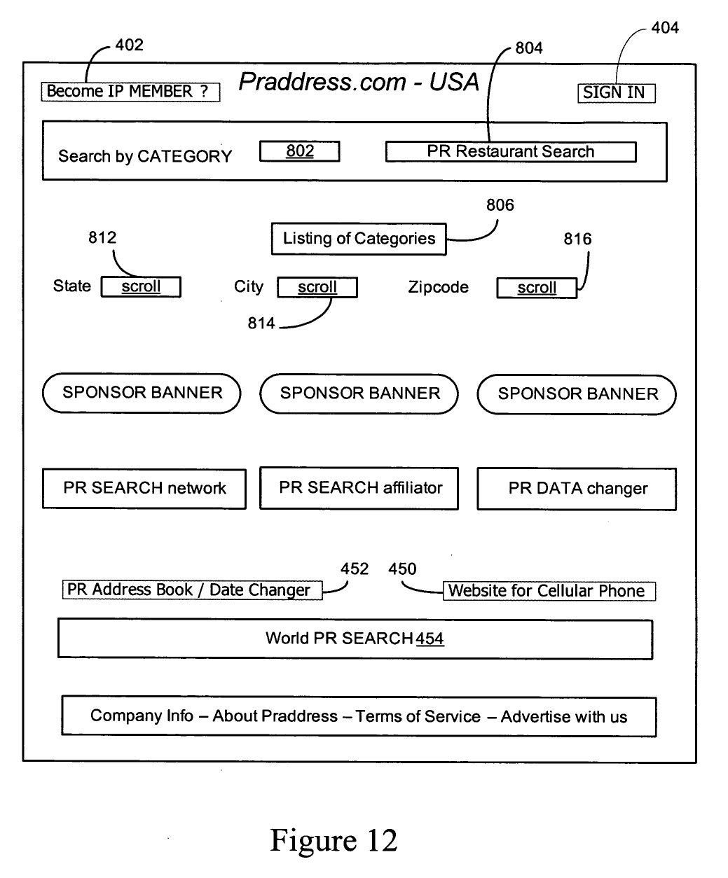

At 426, there is a clickable button is labeled “Cellular Phone User with Internet Connection—Click HERE to send a PRaddress Search Engine template to your email.” This button allows a Cellular Phone/PDA/Palms/Blackberry/PHS/AOL and other Data Communication Terminal users with an Internet connection to send by e-mail or download a template of PRaddress search engine. As used here, “cellular user” includes Palm, Blackberry, PHS/AOL with Internet connection, etc. A cellular user with internet connection is taken to a web page designed for cellular users using the form factor of a typical cell phone, PHS or PDA screen, such as, for example a Wireless Application Protocol (WAP) enabled web page. An example is shown in FIG. 12.

At 424, there is a clickable button is labeled “Cellular Phone User with text message and Internet Connection—Click HERE to send a Category/Subject/Code list to your email.” Here the intended user is a cellular phone user, Palm device user, PDA user, Blackberry user, PHS user, AOL user. Using this button, a cellular phone user without Internet connection to send a PRAddress Yellow Page (Listing of IPs with code number, code name, company name, Category and location) by e-mail with text files. The lists that will be sent might be limited depending upon what kind of message service IR made a contract with cellular phone carriers, message service carriers or Short Message Service (SMS).

At 428, there is a clickable button is labeled “PC/Notebook User with Direct Connection—Click HERE to send a PRaddress Search Engine template to your email.” This button allows a PC/Notebook user with a dial-up (direct) connection to download a template for inputting a search request to the search engine. After this template has been downloaded, a PC/Notebook user can upload a search request to the server and find information made available by IPs without accessing a web page of PRaddress.com. Once an IR user downloads the PR search engine FORMAT into a PC/Notebook/PDA/Palm/Blackberry/PHS/Cellular phone, the IR can use PR system immediately.

A dial-up connection is available to PR server 100 through a network associated with the PR server. Thus, PR server 100 can be accessed without the Internet and without the need to follow Internet communication protocols. Of course, many users will access PR server 100 via the Internet. For example, the dial-up connection can be used in connection with a service program in which the PR system becomes a selectable item (charge or at free of charge) of a service menu operated by a cellular carrier, a packet data network or other type of network supporting wireless PDA/ Palms/Blackberry/PHS or the like, or on the service menu of other types of wireless networks, such as Fiber/Cable/Fiber Cable/Satellite, Internet Service Providers (ADSL, DSL, Dial-up), AOL and Search engine Companies. Thus, there is provided easy access for all to PR server 100 without the need to set up hundreds of access point for dial-up (direct) connection by utilizing above existing facilities.

At 432, there is a clickable button is labeled “Cellular Phone User with Direct Connection—Click HERE to send a PRaddress Search Engine template to your email.” This button allows a Cellular Phone/PDA/Palms/Blackberry/PHS/AOL and other Data Communication Terminal users with a dial-up (direct) connection to send by e-mail or download a FORMAT of PRaddress search engine. As used here, “cellular user” includes Palm, Blackberry, PHS, AOL with Internet connection, etc. A cellular user with internet connection is taken to a web page designed for cellular users using the form factor of a typical cell phone or PDA screen, such as, for example a Wireless Application Protocol (WAP) enabled web page.

At 430, there is a clickable button is labeled “Cellular Phone User with text message and Direct Connection—Click HERE to send a Category/Subject/Code list to your email.” This button allows a cellular phone user with a dial-up (direct) connection to PRAddress Server (limited with text message only) to send a Yellow Page (Listing of IPs with code number, code name, company name, Category and location) by e-mail with text files. The lists that will be sent might be limited depending upon what kind of message service IR made a contract with cellular phone carriers, message service carriers or Short Message Service (SMS).

PR Server 100 provides service through a dial-up (direct) connection (blocks 428, 432, 430). For users (IP and IR) who connect in this manner, the PR system does not have to follow any particular Internet protocol requirements. A dial-up connection can be utilized by having a service program accessed via a menu selection such as offered by a cellular carrier. Such connection could be free of charge or on a fee for service basis depending on the business model selected. Such service can be made available to cellular subscribers through cellular carriers, to PDA users (Palm devices, Blackberry devices, PHS devices and other wireless data devices through various carriers including but not limited to Fiber Cable/Cable/Satellite Carries, Internet Service Providers (ADSL, DSL, Dial-up), AOL and Search engine Companies. Then PRaddress.com doesn't need to invest to set up hundreds of access point for dial-up (direct) connection by utilizing above existing facilities.

By clicking on button 440 a user can see a listing of “network partners” that together constitute the PR System network. Some of these partners may be companies who have their own networks and have made some agreement with the PR system to provide access to the PR servers. Examples of such network partners include:

cellular carriers, PDA networks/Palm networks/Blackberry carriers/PHS and other data wireless communication carriers, fiber cable/cable/satellite carries, Internet Service Providers (ADSL, DSL, Dial-up), AOL and search engine Companies will be suitable network partner for PRaddress.com. As each one of above companies already has millions of users (customers). If they start the PR system as a new service program for their existing users (customers) under a licensing agreement with PRaddress.com, they will generate a new income source of an advertising sale by PR system. The benefit for PRaddress.com for a Licensing agreement is that 1) It will be possible to get millions of IR users and IP members at once when PRaddress.com make a Licensing agreement with one of above companies. 2) PRaddress.com is able to utilize their access points for Dial-up connections. 3) PR address.com will be expanded globally using their computer systems and servers. 4) PR system will be common to the public rapidly.

A clickable button at 442 displays a list of “Category Distributors”. Category distributors are businesses that have an agreement with the PR system to administer one or more of the “categories” into which IPs are organized. They are responsible for promoting the PR system to businesses that relate to their assigned “category”. In the examples described thus far, there are eighteen (18) categories into which IPs can self select. A category distributor might enter into an exclusive agreement with the PR system to promote use of the PR system among business that relate to a particular category such as, for example, “Music”. The total of distributors is up to 18 at present (might be deleted or added). Thus, PRaddress.com is able to concentrate for expanding PR system throughout the world

### EXAMPLE 1

T-Mobile Cellular Company has 12 million subscribers in the US. T-Mobile wants to use our PR solution within their T-Mobile subscriber base. T-Mobile is able to start a new service and generate a new income stream by licensing our PR solution.

### EXAMPLE 2

AOL is an Internet Service Provider (ISP) with 15 million dial-up and broadband users and wants to use our PR solution. AOL can inaugurate a new service and create a new revenue stream by licensing our PR solution.

### EXAMPLE 3

Palms PDA Company sells Personal Digital Assistant (PDA) devices and has a large customer base and operates a packet data network for providing messaging and Internet information access. Palms can make an OEM/Licensing agreement with PRAdress.com to offer access to PRaddress.com.

A clickable button at 444 allows a user to view a list of “partners” who have made the PR system a selectable menu item on their own systems. This list might include, for example, a cellular company that has a service menu system and has made the PR system a menu choice on that service menu system. The list of such “partners” could include cellular carriers, PDA/Palms/Blackberry/PHS and other data wireless communication carriers, fiber cable/cable/satellite carries, Internet Service Providers (ADSL, DSL, Dial-up), AOL and Search engine Companies. In order for the PR system to take advantage of dial-up (direct) connection infrastructure already in place (428) (432) (430), the PR system makes agreements to become “service menu items” on other's systems, such as becoming a menu choice on a service menu of a cellular carrier.

A clickable button at 446 allows a user to view a list of PR “subjects” Distributors. PR Subject distributors are businesses that have an agreement with the PR system to administer one or more of the “subjects” into which IPs upload information for distribution. The subject distributors are responsible for promoting the PR system to businesses that relate to particular “subjects”. In the examples described thus far, there are sixteen (16) “subjects” of information that IPs may use. A subject distributor might enter into an exclusive agreement with the PR system to promote use of the PR system among business that might want to promote information of a type that is one of the “subjects” of the PR system—such as, for example, “Jobs”. A subject distributor for jobs might be an employment agency who specializes in advertising and promoting job opportunities. The number of “categories” and “subjects” is flexible and is expected to change with demand.

At 450 there is a clickable button called “Website for Cellular Phone” to take the user to a special web page set up for cellular phone users.

At 452 there is a clickable button called “PR Address Book/DATA charger”. The PR address book is compilation of all of the IPs along with their respective code numbers and code names that are stored in database 248 along with other pertinent company information such as, for example, name, street address, city, state, zip code, type of business (category), etc. This information can also be published in hard copy as a “PR address book” in a fashion similar to that of a “yellow pages” phone directory. IPs can be listed in one section by code number and in another section by code name, for example. As IPs are added and data about IPs is updated electronically, the complete “book” of IPs or portions of the list of IPs can be published as a promotion of the PR system. When an IR has an opportunity to buy a hard copy of the PR address book, the IR can identify a particular IP whose information is sought and can utilize the PR system easily by searching all listing of code number and code name of IP members from the PR address book.

PR DATA charger is list of support companies that users can visit to upload the latest PR data into their cellular phone/notebook/PDA/PALM/Blackberry/PHS/etc. This includes receiving the latest device formats to allow these various types of devices to interface with the PR server. The main data to transport is a PR address book (otherwise, a PR code list, or a PR yellow page) consisting of three ways of Index, 1) Code number starting from 1-99999999, 2) Company name (alphabetically) divided by each Sates, 3) Category (Type of business). Since these Data are made by text file, anyone can import for no matter, Internet connection, dial-up connection or no internet connection even though the capacities are limited depending upon a service contract with Carries that IR use.

### EXAMPLE

Verizon Wireless agrees to provide PR data transport to all Verizon Wireless stores in the New York metropolitan area. PRAddress stores the latest information to supply to each terminal server at each store of Verizon Wireless. Whenever an information recipient wants to update PR data, he can stop at a Verizon Wireless store and connect a cable between his device (cell phone, notebook, PDA, Palm device/Blackberry/PHS/etc. free of charge.

An area is provided at 454 for a World PR Search. In this area, the information providers are organized geographically. As an example, there are listed major areas and countries as follows:

| Europe/ | Asia/Pacific | North/South |
|---|---|---|
| Middle East | Americas | America |
| UK/Ireland | China | USA (English) |
| France | Hong Kong | USA (Spanish) |
| Germany | Taiwan | USA (Chinese) |
| Italy | Japan | USA (Korean) |
| Spain | Korea | Canada |
| Sweden | Singapore | Mexico |
| Denmark | Malaysia | Brazil |
| Norway | Thailand | Argentina |
| Switzerland | India | |
| Russia | Australia | |
| UAE | New Zealand | |

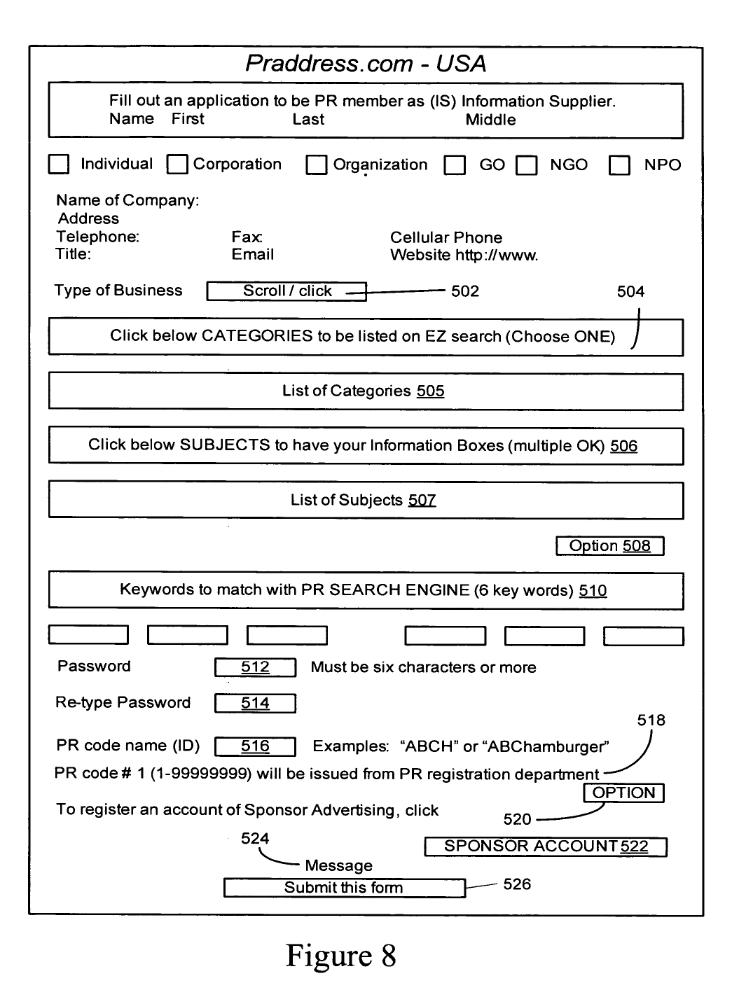

FIG. 8 is a schematic diagram of a web-based form that appears to a user who clicks the “Become a Member?” button 402 on the homepage described with respect to FIG. 4. The prospective member is presented with a form to be filled in with various pieces of information about the user that is later used to set up an account for the user to become an information provider. The prospective IP member provides data about his company/business and provides some keywords that can be put into the search engine for identifying his business to users who use the search engine in that manner. The information supplier is given a PR Name such as “ABCH” or “ABChamburger”, and is asked to define a password. PRAdress.com, after receiving the information obtained by the form, issues a PR code which can be identified to potential users and searched.

A clickable button 502 called “scroll/click” allows the user to scroll and choose the type of business and category to be listed for a search engine. For example: Business & Economy→Food & Drink→Restaurant→Hamburger→ABCh.

At 504 the user can use select boxes to choose ONE category with which it is to be affiliated. The PR system may provide that a third party manage each CATEGORY under certain terms and conditions. However, PR system manages the Category search as a unified database server.

At 506 the user can use select boxes to choose any “subjects” under which to list information. The user can edit and update PR Information from IP member page at anytime. The “subjects” organization may change from time to time based on data capacity, changing interests, commercial purposes, etc. At 508 the user can choose OPTION to have made available a large capacity data server for Information to be provided. Some IPs may have very large data needs and may want to purchase additional space beyond normal amounts for a an additional fee. At 510 the user can choose keywords (six shown for convenience only in the FIG. 5) to be stored in a database of the search engine so that an IR can easily find the IPs information by typing in such key words.

At 512 and 514, the user can select and confirm a password so as to maintain secure future access to the PR server.

At 516 the user can suggest a PR code name. This code name may be related to the company name, an organization name, a product name, etc. Hopefully, it is a name that is simple and easily remembered. This PR code name serves as one more possible “entry” point into the system that an IR can use to access the IP's information.

At 518 a PR code number will be provided automatically and free of charge by the PR system. However, if the IP member wants to select a particular number, an OPTION is available at 520 to enable selection by the IP member for a fee. The IP member is encouraged to use his newly acquired PR code name and PR code number on it's business communications, such as business card, website, TV advertising, posters, brochures, etc. to acquaint people with these identifiers.

At 522 once the IP member is registered as a banner/advertising sponsor account, they can advertise anytime. There is a message 524 displayed near the bottom of the page. For example, the message might read:

“By submitting your registration information, you indicate that you agree to the Terms of Service and have read and understood the PR address! Privacy Policy. Your submission of this form will constitute your consent to the collection and use of this information and the transfer of this information to the United States or other countries for processing and storage by PR address! and its affiliates. You also agree to receive required administrative and legal notices such as this electronically.”

Once the user has completed the form, it is submitted with a click to the “submit this form” button 526.

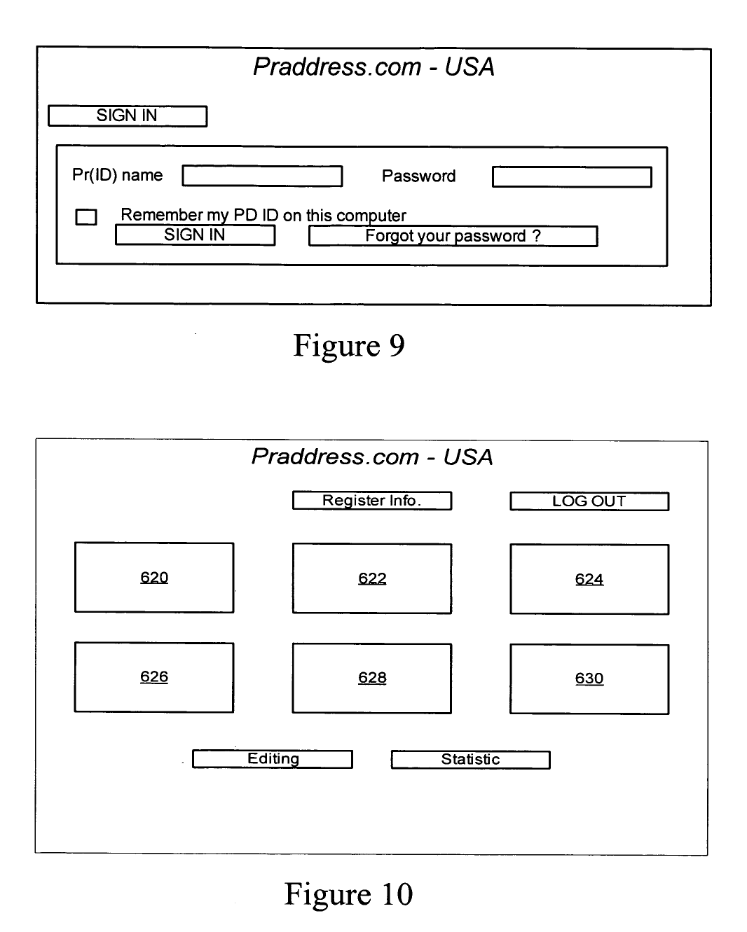

FIG. 9 is a schematic diagram of a sign in web page. There is provided an interactive box 602 in which the member can enter his ID name and a box 604 in which the member can enter his password. A check box 606 makes a “cookie” available for remembering the ID so that the user does not have to retype it for each access. A “sign in” button 608 allows the user to submit the entered information. A “forgot your password” box 610 is provided for users who need help refreshing their memory of the password. By signing in with a PR code(ID) number and password, the member is taken to a an interactive form shown in FIG. 6B.

FIG. 10 is a schematic diagram of a web page that acts as a gateway for the IP member. It includes clickable areas allowing the member to get helpful information, such as: “How to use PRAdress.com” (620), “About Contents of Subject Box” (622), “Regulation of Contents” (624), Paid Contents of Subject Box” (626), “About paid advertising” (628), and “Frequently Asked Questions” (FAQ) (630). This page also permits the member to inter information to be provided to users, such as “Info.”, “PR” “Job Offer”, “Press”. The member can edit (632) information entered into the system such as “New”, “Sale”, “Special”, “Coupon”, “Discount” and so on. The member can receive statistics (634) from the system indicate usage by users who identify the member by requesting information. These statistics can include “Log Analyzer”, “Subject”, “Date”, etc. This page can also include information about capacity. For example it might display a message: “Capacity of Free Subject is up to 10 MB with text message only. Pictures and Html files with extra capacity will be optional.” As another example, the following message might be displayed: “Capacity of Paid Subject is up to 100 MB with text message only. Some users may want to provide space intensive information such as photos and html files, so capacity statistics and the ability to purchase extra capacity will be provided.

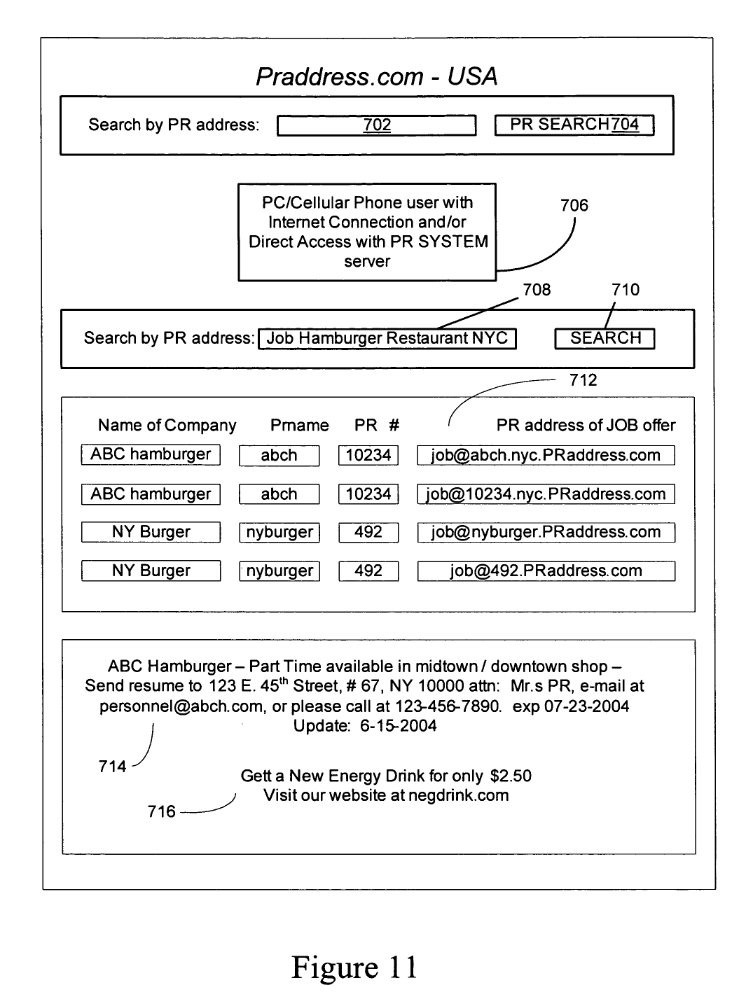

FIG. 11 is a schematic drawing of a web page to which a user is taken from the “Search by PR address” portion of the home search page shown in FIG. 4. An interactive box 702 is provided for the user to enter search words (for example, key words). A clickable button 704 then executes the search. The PR search engine can be searched by PR code name such as abch, Company name such as “ABC Hamburger”, or PR code number, such as “10234” to get a direct access. The PR search engine could be searched by directory and subject to get matching lists.

A PC/Cellular phone user with an Internet connection can activate button 706 and, for example, search by PR address: “Job Hamburger Restaurant NYC” for example, if the user wanted to determine if there were any job offers posted by hamburger restaurants in New York.

The following results might be returned in area 712 in response to the search.

| Name of | | | |
|---|---|---|---|
| Company | PRname | PR# | PR address of job offer |
| ABC | Abch | 10234 | job@abch.nyc.PRaddress.com |
| Hamburger | | | |
| ABC | Abch | 10234 | job@10234.nyc.PRaddress.com |
| Hamburger | | | |
| New York | Nyburger | 492 | job@nyburger.PRaddress.com |
| Burger | | | |
| New York | Nyburger | 492 | job@492.PRaddress.com |
| Burger | | | |

Clicking on the second of the four results would provide the following message in area 714:
“ABC Hamburger—Part Time available in midtown/downtown shop—send resume to 123 E. 45^{th} Street #67, NY 10000 Attn: Mrs. Smith at personnel@abch.com, or please call at 123-456-7890. Exp 07-23-2004, updated 6-15-2004”

As an extra “bonus” the user might receive an advertising message or even a discount coupon in area 716 from an advertising sponsor such as:
“Get a New Energy Drink for $2.50—visit our website at negdrink.com”

FIG. 12 is a schematic diagram of an exemplary web search page illustrating a search that was begun by accessing “PR Category”. The PRaddress system provides a separate and distinct web page for each representative business category. In this example, the user types in “nyc restaurant hamburger” in interactive block 802. The subject heading “PR Restaurant SEARCH” is selected in block 804. (Example: http://www.PR-Restaurant.com)

This web page is devoted to restaurants. Thus, in this example, ABC Hamburger would be included in the database whose information is displayed on this page. In area 806 there are displayed sub-categories of restaurants, for example:

| | | | | |
|---|---|---|---|---|
| Pizza | Hamburger | Sandwich | Bakery | Delivery |
| Catering | Continental | Italian | French | Kosher |
| German | Russian | Spanish | Mexican | Chinese |
| Korean | Japanese | Thai | | |

Scroll boxes 812, 814 and 816 provide the user the ability to zero in on a geographical location of interest.

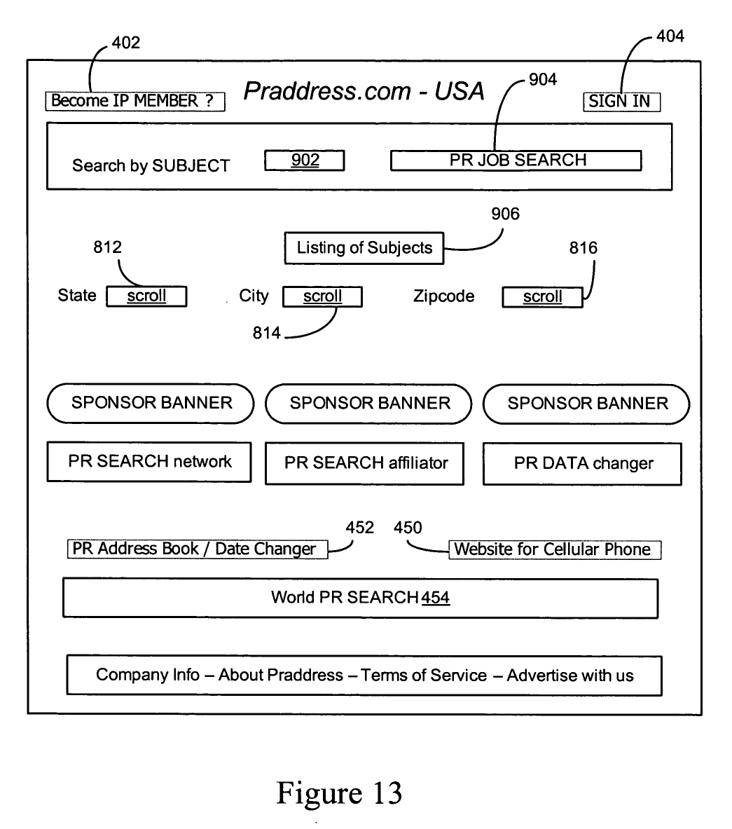

FIG. 13 is a schematic diagram of an exemplary web search page illustrating a search that was begun by accessing PR SUBJECT. In this example, the user is trying to locate a job. The web page shown in FIG. 9 could be retrieved as a result of a user's direct access from the home page through a search or category/subject selection. For example, http://www.PR-job.com. PR system will be more practical and convenient PR information service for both IR and IP by managing an Independent Subject Server. In the example shown in FIG. 9, the user typed “nyc restaurant hamburger” in a search term block 902 and performed a PR JOB SEARCH at block 904. A listing of more narrowly defined “subjects” appears in an area 906, such as, for example:

| | | | |
|---|---|---|---|
| Restaurant | Retail Stores | Operators | Receptions |
| Sales | Department | Accountant | Attorney |
| | Stores | | |
| Entertainment | Public Officers | Engineering | |

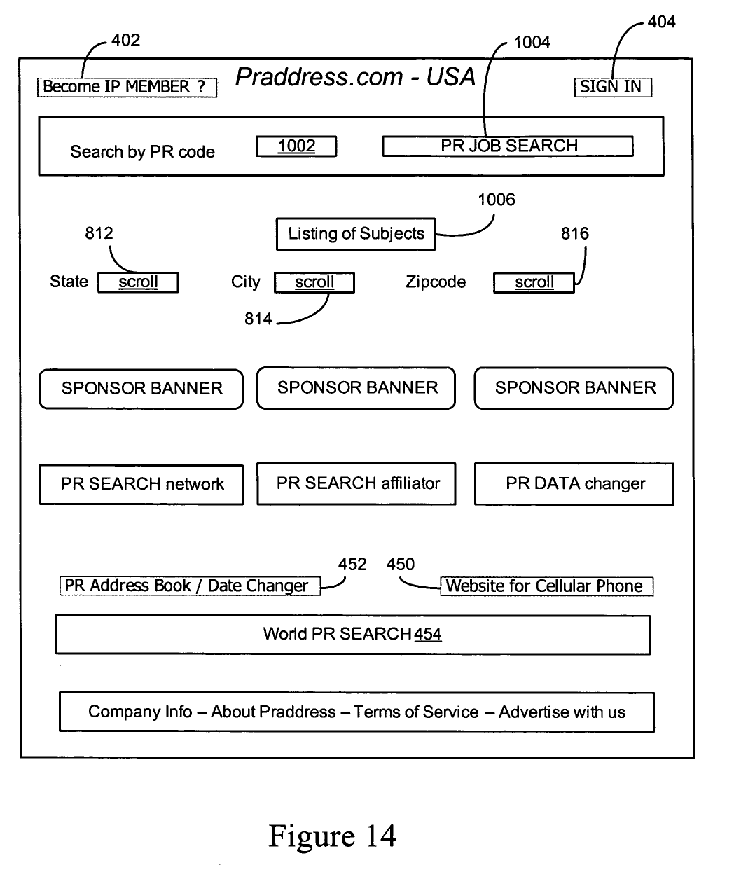

FIG. 14 is a schematic diagram of an exemplary web search page illustrating a search that was begun by accessing PR-code. A PR Information Provider (IP) will be assigned a PR code number 1-99999999. If an Information Recipient (IR) knows a PR code number of ABC Hamburger—10234 as an example and wants to obtain job offer information in New York City, the IR can easily access by entering “10234 JOB NYC” as key words in a search field 1002 and then click on block 1004 to input to a PR SEARCH engine.

In the alternative, the user can simply send an email to JOB@10234.PRaddress.com AND/OR Search by PR code number: If an IR knows a PR code name of ABC Hamburger—ABCh as an example and wants to get a JOB Information for New York City, IR can quickly access by writing “ABCh JOB NYC” as keywords in the search field or by simply sending an email to JOB@ABCh.PRaddress.com

Sponsor Banners are available on various web pages constituting PRaddress.com. For example:

a—PR address Top page for PC/Cellular Phone with Direct Access

b—PR address Web page for PC/Cellular Phone with Internet Access

c—PR address Top page for PDA, Blackberry, Palms, AOL, SMS, Text Message

d—PR Category Top page (18 categories at present)

e—PR Subject Top pages (16 “subjects” at present)

f—PR subject boxes updated by (IP) Information Providers

For example, if PR system has 10,000 IP members with 16 “subjects”, 160,000 Information Boxes are available for Information Recipients to get.

g—PR Information return mails from PR Information Suppliers.

If one million of IR use PR system to receive any PR mails from IP or watch PR Boxes (Boards) from IP daily, then PR system will be able to receive an banner advertising fee of 30 millions per month from Banner Sponsors. As an example, $10 charge per each mail/view, a monthly advertising sales will be US $3 million for (g) only.

The PR System provides “home” web pages for various types of users: PC user, mobile phone user, users of data communication terminals having Internet access, users of text messages, etc. Thus, the system is substantially universal in its ability to provide service to all.

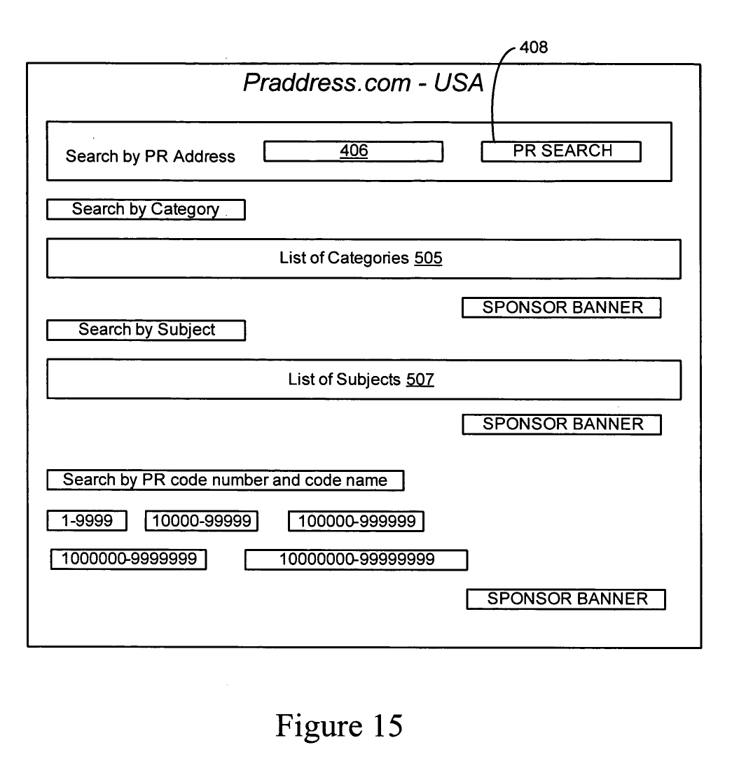

FIG. 15 is a schematic diagram of an exemplary web page that would appear to a user who has clicked on block 422 shown in FIG. 4. This particular page is intended for use by a PC/Notebook User with an Internet connection. An IR can download a template of PR search engine if IR wants to. It is also recommended that IR should download a latest PR address book. The PR search engine is not like other search engine (Yahoo, Google, MSN, Excite and others) that appear thousands of lists after input some keywords. IR needs to input keywords as least one of Categories, one of Subject, and State even if IR doesn't know a company name, a PR code number or a PR code name. With this, IR can get a PR Information by a return e-mail or a viewing by a message box (board) on a screen.

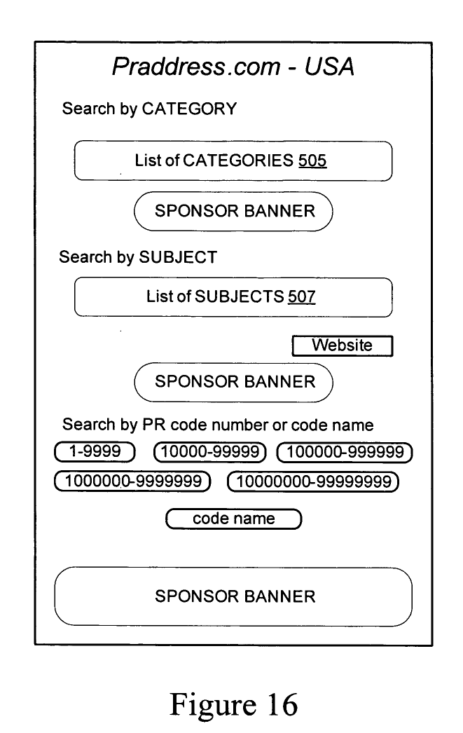

FIG. 16 is a schematic diagram of an exemplary web page used by a cellular phone based IR who does not have an Internet connection. This page is formatted for the small size and aspect ratio of a cell phone display. This page allows such a user to send a Category/Subject/Code list to the user's email address. A cellular based IR without an Internet connection can utilize the PR system via text messaging even without an Internet connection. One such text messaging service is the so-called short message service (SMS) provided by many cellular carriers. Others include AOL Instant Messenger Service, etc.

Since the IR can not download formatted email or browse through Internet, the IR has to access with PR system by writing a concrete subject with a IP code name or a code number into an e-mail address such as “job@ABCh.nyc.address.com” or “job@10234.nyc.address.com”. In response, the PR system will send Job Information of ABC Hamburger in NYC by an automated return mail with a text message to the IR.

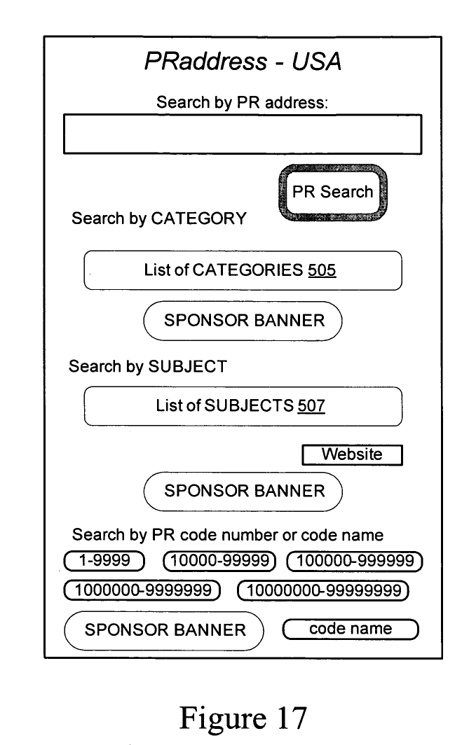

FIG. 17 is a schematic diagram of an exemplary web page used by a cellular phone based IR that may or may not have an Internet connection. The “web” page is formatted for the small size and aspect ratio of a cell phone display. The user can search by CATEGORY or SUBJECT by selecting from a list of categories 505 or a list of “subjects” 507. The IR can also search by selecting code numbers. The code numbers are organized into ranges of code numbers each assigned to a clickable button for easy selection by the user. The IR can obtain PR Information by receiving a return e-mail or by viewing by a message box (board) on the cellular display.

A cell phone based IR can take advantage of a direct connection to the PR server using the network associated with the PR system. In this way, the PR system can provide access to all search engines and web pages directly to a cell phone based IR.

The cellular formatted “page” shown in FIG. 13 is also of the type seen by a cellular phone based IR who can dial a direct connection to PR server 100 by using the network associated with the PR system. Accessed in this manner, the PR system can make available to the IR all search engines and web pages. The IR can get PR Information by a return e-mail or a viewing by a message box (board) on a screen.

The PR search network includes companies/groups/organizations which enter into an agreement with PRaddress.com, such as, for example an OEM agreement or licensing agreement.

The following are examples that illustrate the concept of “network” described above.
Network Example # 1
XYZ-Mobile (a cellular carrier) has 13 million subscribers in the US.
XYZ-Mobile wants to use the PR system described herein and make it available to its subscribers. XYZ-Mobile offers a new service by licensing the PR system and receives advertising income for its use.
Network Example # 2
BigISP, an Internet Service Provider, has 20 million dial-up subscribers and ADSL Internet users in the US. BigISP wants to offer the use the described PR system as a new service to BigISP subscribers.
BigISP is able to add PR system access as a new service and receive an additional revenue stream based on PR advertising by licensing the PR system.
Network Example # 3
PopPDA has 5 million users in the US. PopPDA wants to offer the use of the PR system within its PopPDA user group. PopPDA is converting our PR system as their original version as an additional PR advertising income source to PopPDA users under a licensing agreement with PRaddress.com.

The PR system described herein can be utilized by PDA customers on packet data systems and other communication networks, cellular customers, PHS customers, SMS device users, users of cable based communication systems, satellite based communication systems, ADSL and DSL customers, etc.

A PR category distributor is a company/group/organization which enters into a distributor agreement with PRaddress.com with regard to a particular category (one of the 18 categories in the examples described above).

Category Example #1
Consider, for example the MUSIC category., The PR System has define, for example, 18 categories with which IPs can identify. A company can be designated as the “distributor” or “promoter” for the category “music”. HappyTune, Inc. is a music promotion company that agrees to be such an exclusive distributor of the PR system for the music industry. HappyTune, Inc. provides a server dedicated to the music industry and associates with it a domain, such as, for example, http://PR-MUSIC.com. HappyTune, Inc. sets up its server to include 16 PR “subjects” related to the general category of “music”. HappyTune, Inc. servers link with PR system main server. HappyTune, Inc. promotes the PR system to sign up IPs affiliated with the music world and to advertise to IRs the existence of a PR server dedicated to music.

The PR system can promote itself in part by establishing a service program into other data communication carriers. For example, it could be accessed via a link from a menu of a data communication carrier service program or Internet homepage. For example, if No-wire, Inc. agrees to have a PR system be selectable as a service menu choice for No-wire, Inc customers under a certain agreed upon conditions. The PR system then becomes accessible to No-wire, Inc. customers acting as a gateway for the PR system.

Main targets will include Internet Service Providers, Carriers, Cellular Phone Carriers, PDA/PHS/Mobile Communication Carriers, Cable, Fiber Cable Carriers, satellite carriers, search engine companies, ADSL, DSL carriers, etc.

A PR “subject” distributor is a company /group/organization which enters into a distributor agreement with PRaddress.com as to one “subject” area (16 “subject areas” have been described in the examples above. Each distributor can market and promote the PR system specializing in a designated “subject” such as “sale”.

### EXAMPLE

SPC, Inc., a sales promotion company agrees with PR system to be an exclusive distributor/promoter of the PR system for the “sale” subject matter. SPC, Inc. establishes an Internet domain such as http://www.PR-SALE.corn and sets up a server with 18 “categories” of business that may be related to “sale”, such as

| | | | | |
|---|---|---|---|---|
| News | Sports | Movies | Music | Health |
| Beauty | Friends | Autos | Laws | Weather |
| Travel | Education | Money | Real Estate | PC & Mobile |
| Internet | Restaurant | Food & Drink | | |

SPC, Inc. servers link with PR system main server. SPC, Inc. promotes the PR system and signs up IPs who want to advertise their respective sales information. In return, SPC, Inc. is paid a percentage of sales from PR advertising fees related to the “sale” subject.

As previously stated, a user can connect with PR server 100 through the Internet or through a dial-up direct connection. One example of a dial-up direct connection is the “i-Mode” service offered by NTT DoCoMo in Japan. A cellular subscriber to such service can connect, via a service menu choice on his cellular phone to an i-mode server to use various kinds of service menu programmed/operated by NTT DoCoMo.

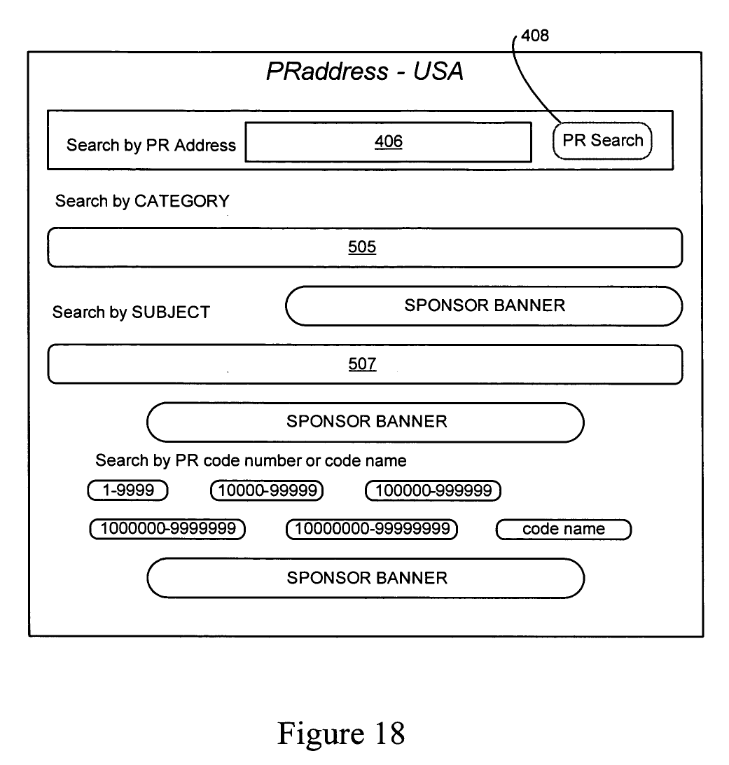

FIG. 18 is a schematic diagram of an exemplary web page used by a PC/Notebook user with a DIRECT connection to PR server 100. It is possible to directly connect to the PR server using a network associated with the PR system. The PR system can thus provide access to all search engines and web pages directly to those without other access. Using such a connection, an IR can obtain PR Information in a automated return e-mail or by viewing by a message box (board) on a screen.

The e-mail addressing scheme described above is not the only manner in which e-mail addresses can be composed and utilized. Alternative e-mail addressing schemes can and should be used when there are technical incompatibilities among the various systems that must communicate. For example, consider an IR user who wants to access PR server 100 (PRaddress.com) to look for a job in New York City at an ABC Hamburger Shop. There are various ways to find the information sought.
a) If the IR user is a PC user with an Internet connection, he can point his browser directly to the homepage of PR server 100, namely www.PRaddress.com.
b) If the IR user is a cellular customer with an Internet connection, he can access the PRaddress.com web page formatted for the small screen of a cellular phone (for example WAP formatted page) through the Internet.
c) If the IR user is a cellular customer without an Internet connection, the IR can access a PRaddress.com web page designed for non-Internet users using an available text based message service, such as SMS, instant messaging, etc.

The situation represented in (b), above, is one that might be appropriate for alternative addressing. Normally, a user would write an email address to obtain the desired information such as the following: job@abch.nyc.PRaddress.com or job@10234.nyc.PRaddress.com. The PR server would, in response to such email, send a reply email containing the desired information about job availability of ABC hamburger in NYC.

The easiest way to use our PR system is to access directly to PR server 100. PR Server 100 has associated with it an independent PR service system. This service system has its own access numbers to communicate compatibly with various types of users, such as PC users, cellular phone users, PHS users, PDA users, etc. whether or not they have Internet access.

As explained with respect to FIG. 3 (14)(15)(16), PRaddress.com is able to provide services without using the Internet by having available dial-up (direct) connection access. PRaddress.com will utilize this dial-up connection by having a service program of PR system as one of service menu (charge or at free of charge) operated by Cellular Phone Carriers, PDA/Palms/Blackberry/PHS and other data wireless communication Carriers, Cable/Fiber Cable/Satellite Carries, Internet Service Providers (ADSL, DSL, Dial-up),AOL and Search engine Companies. Then PRaddress.com doesn't need to invest to set up hundreds of access point for dial-up (direct) connection by utilizing above existing facilities.

By providing our own direct connection system, we can set up our PR service as a menu choice provided by any cellular carrier, etc. For example, NTT Docomo (A largest cellular phone carrier holding 55 million customers in Japan) can offer the PR server information as a choice on its “i-mode” service. Similarly, Sprint could offer our PR server information as a menu choice to its customers. Thus, a cellular user, such as an NTT customer who has a cellular phone with i-mode function can access to our PR server directly without Internet connection. Large cellular carriers such as Verizon, Cingular, T-mobile, etc. already have this kind of service (i-mode or something similar) or will start such service in the future.

In order to provide universal service, PR Server 100 has stored a plurality of web pages grouped for various kinds of users:
PC user

cellular phone users (WAP format, etc.)

various data communication terminals with Internet access

users of text message services, such as short message service (SMS)

PR menu users with direct access.

The inventions defined by the claims have been described above partially by providing specific examples. The examples are just that—examples. They are not meant to represent the only way to practice the claimed inventions. Rather, they are included to help the reader understand the principles of the inventions.

1. An information system with which information providers (IP) disseminate information to information recipients (IR) with or without the need for any IR to disclose his identity, comprising:
an information server for storing and dispensing information;
means for allowing a IP to upload information to the information server which is stored therein as data;
means for receiving an information request from an IR indicating that he wants a particular kind of information;
means for searching data stored in the information server and retrieving information requested by the IR; and
means for sending retrieved information to the IR.

2. A system according to claim 1 wherein the means for receiving an information request comprises means for receiving an email message sent to the information server by an IR and the means for sending retrieved information to the IR comprises means for sending an automated email reply message to the IR.

3. A system according to claim 1 wherein the means for receiving an information request comprises means for receiving an information request via an Internet browser interface and the means for sending retrieved information to the IR comprises means for sending retrieved information via an Internet browser interface.

4. A system according to claim 1 wherein the means for receiving an information request comprises means for receiving an information request via a text messaging system associated with a cellular carrier and the means for sending retrieved information to the IR comprises means for sending retrieved information via a text messaging system associated with a cellular carrier.

5. A system according to claim 1 wherein the means for receiving an information request comprises means for receiving an information request via a packet data system and the means for sending retrieved information to the IR comprises means for sending retrieved information via a packet data system.

6. A system according to claim 1 wherein information uploaded by an IP to the information server is organized into a plurality of “subjects” and an information request from an IR specifies at least one subject of information to be retrieved.

7. A system according to claim 2 wherein information uploaded by an IP to the information server is organized into a plurality of “subjects” and an information request from an IR specifies at least one subject of information to be retrieved.

8. A system according to claim 7 wherein the subject of information requested is indicated by a portion of the addressee of the email sent by the IR.

9. A system according to claim 1 wherein an IP is assigned a code identifier by the system.

10. A system according to claim 9 wherein an IP whose information is sought by an IR is indicated by including the code identifier as a portion of the addressee of the email sent by the IR.

11. A system according to claim 2 wherein the email message reply to the IR includes a banner sponsor message.

12. A system according to claim 3 wherein a banner sponsor message is included with the information retrieved and sent to the IR.

13. A system according to claim 1 further comprising:
means for affiliating a code identifier to each IP;
means for assigning a category with which each IP is affiliated;
means for organizing information uploaded to the information server by each IP into a plurality of “subjects”; and
wherein the means for searching includes means for searching for information related to IPs that are affiliated with the code identifier.

14. A method of distributing information, comprising:
uploading information to an information server from an information provider (IP);
organizing the information collected from the IP and storing it as data on the information server;
receiving an information request from an information receiver (IR) indicating that he wants a particular kind of information;
searching data stored in the information server and retrieving information requested by the IR; and
sending retrieved information to the IR.

15. A method according to claim 14 wherein the receiving of an information request comprises receiving an email message sent to the information server by an IR and the sending retrieved information to the IR comprises sending an automated email reply message to the IR.

16. A method according to claim 14 wherein the receiving an information request comprises receiving an information request via an Internet browser interface and the sending retrieved information to the IR comprises sending retrieved information via an Internet browser interface.

17. A method according to claim 14 wherein the receiving an information request comprises receiving an information request via a text messaging system associated with a cellular carrier and the sending retrieved information to the IR comprises sending retrieved information via a text messaging system associated with a cellular carrier.

18. A method according to claim 14 wherein the receiving an information request comprises receiving an information request via a packet data system and the sending retrieved information to the IR comprises sending retrieved information via a packet data system.

19. A method according to claim 14 wherein information uploaded by an IP to the information server is organized into a plurality of “subjects” and an information request from an IR specifies at least one subject of information to be retrieved.

20. A method according to claim 15 wherein information uploaded by an IP to the information server is organized into a plurality of “subjects” and an information request from an IR specifies at least one subject of information to be retrieved.

21. A method according to claim 20 wherein the subject of information requested is indicated by a portion of the addressee of the email sent by the IR.

22. A system according to claim 13 further comprising assigning a code identifier to an IP.

23. A method according to claim 22 wherein an IP whose information is sought by an IR is indicated by including the code identifier as a portion of the addressee of the email sent by the IR.

24. A method according to claim 15 further comprising including a banner sponsor message with the email message reply to the IR.

25. A method according to claim 16 further comprising including a banner sponsor message with the information retrieved and sent to the IR.

26. A method according to claim 14 further comprising:
affiliating a code identifier to each IP;
assigning a category with which each IP is affiliated;
organizing information uploaded to the information server by each IP into a plurality of “subjects”; and
wherein the searching includes searching for information related to IPs that are affiliated with the code identifier.

27. A method according to claim 26 further comprising:
providing access to the information server via a service menu of a cellular carrier.

28. A method according to claim 26 further comprising:
providing access to the information server via a service menu of a packet data carrier.

29. A method according to claim 26 further comprising:
providing access to the information server via a service menu of a cable network.

30. A method according to claim 26 further comprising:
providing access to the information server via a service menu of a satellite network.

31. A method according to claim 26 further comprising:
providing access to the information server via a service menu of an Internet Service Provider (ISP).

32. A method according to claim 26 wherein an information request by an IR includes the code identifier of an IP whose subject information is sought and one or more subject identifiers of the information sought from the IP and wherein the sending of retrieved information includes information from the IP corresponding to the code identifier the information including the IP's information related to the “subjects” indicated in the IR's information request.

33. A method according to claim 26 further comprising:
publishing an address book of IPs including for each IP at least the IP's name, code identifier and affiliated category.
